(19) United States
(12) Patent Application Publication
(10) Pub. No.: US 2026/0199873 A1
(43) Pub. Date: Jul. 16, 2026

(54) SORBENTS FOR CARBON DIOXIDE CAPTURE

(71) Applicants: BASF SE, Ludwigshafen am Rhein (DE); THE UNIVERSITY OF NOTTINGHAM, Nottingham (GB); PQ SILICAS UK LIMITED, Warrington Cheshire (GB)

(72) Inventors: Stephan HUEFFER, Ludwigshafen am Rhein (DE); Ivette GARCIA CASTRO, Ludwigshafen am Rhein (DE); Tobias Maximilian MERKEL, Ludwigshafen am Rhein (DE); Lee Anthony STEVENS, Nottingham (GB); Colin Edward SNAPE, Nottingham (GB); Simon Richard STEBBING, Warrington Cheshire (GB); Wei LI, Nottingham (GB)

(21) Appl. No.: 19/136,533

(22) PCT Filed: Dec. 19, 2023
(86) PCT No.: PCT/EP23/86718

§ 371 Date: Jun. 6, 2025

(30) Foreign Application Priority Data
Dec. 21, 2022 (EP) 22215665.5

(51) Int. Cl. B01J 20/26; B01D 53/14; B01J 20/10

(52) U.S. Cl. CPC B01J 20/262; B01D 53/1475; B01J 20/103; B01D 2252/2053; B01D 2257/504; B01J 2220/4806; B01J 2220/4812

(57) ABSTRACT

A sorbent for absorbing carbon dioxide from a gas or a mixture of gases includes: (A) polyalkyleneimine or an alkoxylated polyalkyleneimine; and (B) an inorganic solid support for the polyalkyleneimine or alkoxylated polyalkyleneimine (A), in which the alkoxylated polyalkyleneimine (A) is located on the inorganic solid support (B), and the sorbent includes water in an amount of greater than 2 wt. % based on the weight of the sorbent. A process for preparing such a sorbent is provided herein, as well as uses of the sorbent for capturing carbon dioxide from a mixture of gases, such as air.

### FIELD OF THE INVENTION

The present invention relates to solid sorbents for capturing carbon dioxide. The invention has utility in capturing carbon dioxide from a mixture of gases (containing carbon dioxide), for instance from waste gases (such as from combustion processes) or air. The invention provides that the sorbent comprises (A) polyalkyleneimine or an alkoxylated polyalkyleneimine; and (B) an inorganic solid support for the polyalkyleneimine or alkoxylated polyalkyleneimine.

### BACKGROUND OF THE INVENTION

The increasing levels of greenhouse gases in the atmosphere is of growing global concern in view of the predicted impact on climate change. This is particularly so in view of the rising levels of carbon dioxide. It is widely accepted that even the present concentration of carbon dioxide in atmospheric air is responsible for increasing dramatic environmental changes, including droughts, flooding and disruption of ecosystems around the world. It is predicted that, as carbon dioxide levels continue to rise, we are likely to see significant increases in the average temperatures of the atmosphere and oceans leading to increasing melting of polar and glacier ice, which in turn would bring about rising sea levels with the inevitable flooding of low-lying lands. Increased atmospheric temperatures are also expected to increase the likelihood of powerful cyclonic storms globally.

The governments of many countries are aiming to act by legislating with the aim of reducing emissions of greenhouse gases, particularly carbon dioxide, and ultimately limit global warming. Many nations have adopted The Paris Agreement, which is a legally binding international treaty on climate change. Its goal is to limit global warming to well below 2, preferably to 1.5° C., compared to preindustrial levels.

In recent years there has been a great deal of effort placed in developing technologies that can achieve the goal of reducing carbon dioxide levels from atmospheric air and/or gaseous emissions. Capturing carbon dioxide at source is generally regarded as the most cost-effective. Such sources include large carbon-based energy facilities, natural gas processing, synthetic fuel plants, industries with major carbon dioxide emissions, for instance steelmaking and cement production, and hydrogen production plants, which employ fossil fuels.

One dominant carbon capture technology involves absorption or sequestering of the carbon dioxide. It is known to use certain amine compounds for absorbing carbon dioxide. Typical amines used for this purpose include alkanolamines, including monoethanolamine, diethanolamine, diisopropanolamine, pentaethylenehexamine, tetraethylenepentamine, triethylenetetramine, tetraethylenetetramine, bis(2-hydroxypropyl) amine, N,N′-bis(2-hydroxy ethyl)ethylene diamine, alkyl amines, methyl amine, linear polyethyleneimine, branched polyethyleneimine, dimethyl amine, diethyl amine, methyl diethanolamine, methyl ethanol amine, polyethylene polyamine, diethylene tri-amine, N,N′-bis-(3-aminopropyl)ethylene diamine.

U.S. Pat. No. 7,795,175 B2 describes supported amine sorbents that include an amine, or an amine/polyol composition deposited on a nano structured support such as nanosilica. The sorbent is said to provide structural integrity, as well as high selectivity and increase capacity for efficiently capturing carbon dioxide from gas mixtures, including the air. The sorbent is regenerative and can be used through multiple operations of absorption-desorption cycles. The nano structured support can have a primary particle size less than about 100 nm, and can be fumed or precipitated oxide, calcium silicate, carbon nanotubes, or a mixture thereof. The amine can be a primary, secondary, or tertiary amine or alkanolamine, aromatic amine, mixed amines or combinations thereof. In an example, the amine is present in an amount of about 25% to 75% by weight of the sorbent. The polyol can be selected from, for example, glycerol, oligomers of ethylene, polyethylene glycol, polyethylene oxides, and ethers, modifications and mixtures thereof. They can be provided in an amount up to about 25% by weight of the sorbent.

U.S. Pat. No. 9,084,960 B2 discloses a method for reducing the CO₂ content of a gas mixture by contacting the gaseous effluent to be treated with an absorbent that contains a CO₂ trapping agent in the impregnated state on a substrate made of a solid composite material (M) containing a polymer (P) and a compound (C) selected from mineral oxides, silico-aluminates, and activated carbon. CO₂ capture agents according to this disclosure may include mono amines (in particular secondary amines, such as diethanolamine), polyamines, monoguanidines and polyguanidines and mixtures of these compounds. The material (M) is said to have a mean particle size (D50) of at least 100 μm, more preferentially at least 150 μm. Nevertheless, it is indicated that this mean particle size generally is less than or equal to 2000 μm. A pore volume (Vd1), formed by pores with a diameter between 3.6 and 1000 nm, of at least 0.2 cm³/g, and preferably at least 0.4 cm³/g.

U.S. Pat. No. 9,533,250 B2 reveals a sorbent for CO₂ reduction from indoor air from an enclosed space. In some embodiments, the sorbent is said to comprise a solid support and an amine-based compound being supported by the support. The disclosure describes that the sorbent captures at least a portion of the CO₂ within the indoor air. It is suggested that the amine-based compound may comprise any suitable amine, such as a primary or secondary coming, or a combination thereof. The disclosure reveals that the amine-based compound may range from simple single molecules, such as ethanolamine, to large molecule amine polymers such as polyethyleneimine. Suggested in the document are monoethanolamine, ethanol amine, methylamine, branched polyethyleneimine, linear polyethyleneimine, diethanolamine, dimethylamine, diethylamine, diisopropanolamine, tetraethylenepentamine, methyldiethanolamine, methylethanolamine, and any of a number of polyamines such as polyethyleneimine, or a combination thereof. The sorbent includes a solid support and an amine-based compound supported by the support. The support may include a porous solid material or fine particles solid material. It is also suggested that the support may include clay. In addition, such support may include a plurality of particles and it is suggested that such particles can have an average diameter dimension within the range of 0.1 to 10 mm, 0.2 to 3 mm, or 0.3 to 1 mm.

U.S. Pat. No. 11,229,897 B2 discloses carbon dioxide and VOC sorbents that include a porous support impregnated with an amine compound. These sorbents are said to include a gas adsorbing material coated onto the porous support. This gas adsorbing material includes a polyamine produced using a process that is free of formaldehyde as a reaction product and/or a reactant. The disclosure reveals a method of preparing a sorbent by producing reaction solution of a first amine compound and a reactant. The reactant is said to comprise a carbonate ester compound or a ketone compound. The first amine compound would react with the reactant to produce a second amine compound. This second amine compound is impregnated onto the porous support to produce the sorbent. Various porous supports are suggested including clay. Other materials are suggested in a list of different materials which includes silica, zeolite, fumed silica and activated carbon. The porous support is said to have a surface area greater than 50 m²/g prior to impregnation with the second amine compound. Embodiments with average pore volumes are indicated as greater than 0.2 cm³/g and less than 0.8 cm³/g, greater than 0.1 cm³/g and less than 3.0 cm³/g. Another embodiment is described in which the porous support is said to be in the form of granules having a diameter ranging from about 0.25 mm to about 5 mm.

Kim, J. Y. et al., Continuous testing of silica-PEI adsorbents in a lab.-scale when bubbling fluidised-bed system, International Journal of Greenhouse Gas Control, 82 (2019), pp. 184-191 describes a large scale when bubbling fluidised bed system (TBS) used continuously to test the performance for CO₂ adsorption of silica-PEI adsorbents, containing 40 wt. % of PEI. The TBS comprised bubbling bed adsorption and desorption reactors, a riser for pneumatic conveying of solids from the adsorption to the desorption reactor, and a cyclone for solid gas separation. The adsorbent was prepared using PEI with a molecular weight of 800 (S.PEI-0.8K) and was preliminarily tested for nearly 24 hours at given operating conditions by varying the inlet sorbent/CO₂ mass ratio at the absorber to analyse the CO₂ removal efficiency in the adsorption reactor and the dynamic adsorption capacity of the absorbent. A 180-hour continuous test was then carried out by changing various experimental conditions such as the water concentration, reaction temperature, solid layer height, reaction gas flow rate, an inlet sorbent/CO₂ mass ratio at the absorber using PEI with a molecular mass of 5000 (S.PEI-5K) absorbent a CO₂ removal efficiency of above 80% and a dynamic sorption capacity greater than 6.0 wt. % were said to be achieved.

Zhang, W. et al., Process simulations of post-combustion CO₂ capture for coal and natural gas-fired power plants using a polyethyleneimine/silica adsorbent, International Journal of Greenhouse Gas Control, 58 (2017), pp 276-289 describes first assessing regeneration heat for a polyethyleneimine (PEI)/silica adsorbent-based carbon capture system to evaluate its effect on the efficiency penalty of a coal or natural gas power plant. Process simulations are carried out on net plant efficiencies for specific supercritical 550 MWe pulverised coal (PC) and a 555 MWe natural gas combined cycle (NGCC) powerplant integrated with a conceptually designed capture system using fluidised beds and PEI/silica adsorbent. The solid adsorbent used in this study was synthesised by impregnating a mass ratio of 40% PEI into an inorganic mesoporous silica support. The PEI had a molecular weight (MW) of 1800 in hyperbranched forms.

Zhang, W. et al., Cyclic performance evaluation of a polyethyleneimine/silica adsorbent with steam regeneration using simulated NGCC flue gas and actual flue gas of a gas-fired boiler in a bubbling fluidised bed reactor, International Journal of Greenhouse Gas Control, 95 (2020), p. 102975 describes a study on the cyclic performance of a polyethyleneimine/silica adsorbent of kg scale in a laboratory scale bubbling fluidised bed reactor. A high volumetric concentration 80-90 vol % of steam mixed with N₂ and CO₂ was used as the stripping gas during a typical temperature swing adsorption cycle. The adsorbent used in the study was synthesised by impregnating a mass ratio of 40% PEI (polyethyleneimine) into an inorganic mesoporous silica support with BET surface area of approximately 250 m²/g, pore volume of 1.7 cc/g and mean pore diameter of approximately 20 nm. The PEI had a molecular mass of 1800 in hyperbranched forms.

Kim, J. Y. et al., Performance of a silica-polyethyleneimine adsorbent for post-combustion CO₂ capture on a 100 kg scale in a fluidised bed continuous unit, Chemical Engineering Journal 407 (2021) p. 127209 reveals polyethyleneimine (PEI)/silica adsorbents for use in post-combustion CO₂ capture using a 150-hour continuous test using a 100 kg sample of silica-PEI on a fluidised bed continuous unit. The CO₂ removal efficiency and dynamic sorption capacity were evaluated continuously by changing a number of variables. The silica-PEI adsorbent was prepared for the CO₂ capture performance using two different types of silica-PEI with different PEI molecular masses.

Choi, W. et al., Epoxide functionalisation of polyethyleneimine for synthesis of stable carbon dioxide adsorbent in temperature swing adsorption, Nature Communications, 7 (1), pp. 1-8, 2016 relates to scalable synthesis of a functionalised PEI/silica adsorbent which simultaneously exhibits a large work capacity (2.2 mmol g⁻¹) and long-term stability in a practical temperature swing adsorption process. The article describes functionalisation of PEI with 1, 2-epoxy butane reduces the heat absorption and facilitates carbon dioxide desorption (>99%) during regeneration compared with unmodified PEI (76%). Table 1 illustrates 0.15 Epoxybutane PEI/SiO₂, 0.37 Epoxybutane PEI/SiO₂ and 0.54 Epoxybutane PEI/SiO2.

Le, M.U.T. et al., Preparation and characterisation of PEI-loaded MCM-41 for CO₂ capture, International Journal of Hydrogen Energy 39 (2014) pp. 12340-12346, discloses preparing PEI-loaded MCM-41 by first preparing the MCM-41, molecular sieve, using tetraethoxysilane and cetyl-trimethylammonium bromide. Using the wet impregnation method, various weights of polyethyleneimine (PEI) were modified on mesoporous silicate MCM-41 for increasing the CO₂-adsorption capacity. PEI (MW=25,000)-impregnated sorbents were prepared by the wet impregnation method. The desired amount of PEI was dissolved in 6 mL of methanol under stirring for 15 min. The calcined MCM-41 (0.5 g) was subsequently added to the amine-methanol solution and the slurry mixture was stirred at room temperature for three hours and finally the product obtained dried at 80° C. for eight hours under reduced pressure.

Lie, K. et al., The influence of polyethyleneimine type and molecular weight on the CO₂ capture performance of PEI-nano silica adsorbents, Applied Energy, 136 (2014), 750-755 describes amine-silica adsorbents as alternatives to aqueous solutions of amines, which have been traditionally used to capture carbon dioxide (CO₂) from flue gas due to its high thermal stability. The study investigates the influence of PEI type (i.e. branched vs. linear) and molecular weight on the CO₂ capture performance of the PEI-silica adsorbents. PEI molecular weight was said to influence the thermal stability of PEI-silica adsorbents but when the molecular weight was at least 1200 Da the increases stability was negligible in the temperature range of 25-160° C. Branched PEIs were said to achieve higher CO₂ saturation sorption capacity compared to linear PEIs. The study also found that linear PEIs were more stable than branched PEIs during CO₂ sorption-desorption cycling. The PEI-nano silica adsorbents were prepared by dissolving PEI in methanol followed by the addition of the nano silica and then further methanol followed by drying.

Li K. et al., Polyethyleneimine-nano silica composites: a low-cost and promising adsorbent for CO₂ capture, Journal of Materials Chemistry A, 2015, 3, 2166-75 discloses adsorbents for CO₂ capture with nano silica as a support synthesised by impregnating polyethyleneimine into nano silica. The disclosure observes impregnation of PEI into nano silica with 2-40 nm pore of silica support plays an important role in the synthesis process of adsorbents. It is further disclosed that PEI loading content, absorption temperature and CO₂ partial pressure influenced CO₂ absorption capacity and PEI utilisation efficiency. The PEI-nano silica adsorbents were said to be prepared by dissolving PEI in methanol followed by addition of dried nano silica and then addition of further methanol followed by drying.

Park, S. et al., Epoxide-functionalised, poly(ethyleneamine)-confined silica/polymer module affording sustainable CO₂ capture in rapid thermal swing adsorption, Industrial & Engineering Chemistry Research, 2018, 57, pp 13923-13931, describes the formation of PAI/SIO₂/0.37EB-PEI and PAI/SIO₂/PEI. Polyethyleneimine was said to be modified using 1,2-epoxybutane (EB) to form 0.37EB-PEI involving the dropwise addition of EB to the PEI dissolved in methanol. PAI/SIO₂ was then said to be impregnated with the resulting methanol solution mixture and dried.

U.S. Pat. No. 10,010,861 B2 concerns carbon dioxide adsorbents that include a polymeric amine and a porous support on which the polymeric amine is supported. The polymeric amine is said to consist of a polymer skeleton containing nitrogen atoms and branched chains bonded to the nitrogen atoms of the polymer skeleton. Each of the branched chains contains at least one nitrogen and the polymeric amine is modified by substitution of at least one of the nitrogen atoms of the polymer skeleton or the branched chains with a hydroxyl group containing carbon chain. The disclosure describes that the porous support may be any of silica, mesoporous silica, hetero element-doped silica, alumina, hetero element-doped alumina, activated carbon, carbon-based supports. Example 1 describes the synthesis of polyethyleneimines modified by a partial substitution with butylene oxide. This synthesis involves dissolving a polyethyleneimine (MN=1200, 19 mmol N/g) in methanol. The disclosure reveals adding the butylene oxide to the polyethyleneimine/methanol solution in different amounts such that the mole ratio of the butylene oxide to nitrogen atoms present in the polyethyleneimine were 0.15:1, 0.37:1, and 0.54:1. The disclosure reveals removing the solvent by subjecting the solutions of the modified polyethyleneimine to heating in a vacuum oven. This disclosure further teaches using analogous modified polyethyleneimines to form modified polyethyleneimine supported silica. Example 2 refers to impregnation of the modified polyethyleneimine into a fumed silica and example 3 refers to impregnation in a borosilicate. In example 2 the preparation involves adding fumed silica in different amounts of 2.48 g, 3.20 g and 3.92 g to the methanolic solutions of the modified polyethyleneimine. The mixtures were stirred for two hours to allow the modified polyethyleneimine to load into the pores of the fumed silica. The mixture was said to be heated in a vacuum oven at 50° C. for 12 hours to remove the solvent. In example 3, the modified polyethyleneimine was added to a borosilicate support. It is disclosed that 2.96 g of the borosilicate was added to the methanolic solution of the modified polyethyleneimine. The mixture was said to be stirred for two hours such that the solution of the modified polyethyleneimine was sufficiently loaded into the pores of the borosilicate. The mixture was heated in a vacuum oven at 50° C. for 12 hours to remove the solvent.

U.S. Pat. No. 10,751,689 B2, arising from WO/2016/114991A1, relates to regenerative, solid sorbents for absorbing carbon dioxide from the gas mixture, including air. This is said to be achieved using the sorbent including a modified polyamine and a solid support. The modified polyamine is the reaction product of an amine and an epoxide. Example 1 reveals preparing a modified polyamine species based on pentaethylenehexamine (PEHA) and propylene oxide (PO). The preparation describes dissolving 10 g of the PEHA in 40 ml of water and adding 5 g of PO to the PEHA solution followed by stirring for 20 hours at room temperature. The temperature of the reaction mixture was said to be raised progressively to 60° C. which was maintained for two hours. The water was said to be removed by rotary evaporator followed by overnight vacuum at below 1 mmHg. The disclosure reveals preparing a supported polyamine sorbent from this modified polyamine by dissolving 3 g of the modified polyamine in 10 ml of water and then suspending 2 g of Sipernat 50S in 40 ml of water. The solution of modified polyamine was then slowly added to the Sipernat 50S suspension under stirring followed by an additional 20 hours stirring at room temperature. It is disclosed that the water was then removed from the mixture by rotary evaporator followed by overnight vacuum (<1 mmHg). The supported polyamine absorbent obtained was said to be a white solid, which could be crushed and sieved to produce a solid with uniform particle size distribution. Example 2 makes a similar disclosure.

It is an object of the invention to provide solid sorbents for CO₂ efficiently and in an environmentally friendly manner. It is also an object of the invention to provide CO₂ sorbents with desirable CO₂ capture properties, such as desirable rate of CO₂ adsorption and/or CO₂ loading capacity and/or oxidative stability and/or processability.

### SUMMARY OF THE INVENTION

In accordance with an aspect of the present invention, there is provided a sorbent suitable for absorbing carbon dioxide from a mixture of gases, the sorbent comprising:
(A) polyalkyleneimine or an alkoxylated polyalkyleneimine; and
(B) an inorganic solid support,
   the polyalkyleneimine or alkoxylated polyalkyleneimine (A) being located on the inorganic solid support (B),
   wherein the sorbent comprises water in an amount of greater than 2 wt. % based on the total weight of the sorbent.

The sorbent is typically provided in the form of particles. Free flowing particles are particularly preferred. The sorbent particles may be in the form of a powder.

The present application also provides a process for preparing the above-described sorbent, the process comprising:
loading the polyalkyleneimine or alkoxylated polyalkyleneimine (A) onto the inorganic solid support (B), the loading step comprising contacting (A) and (B) in the presence of water and then obtaining the sorbent.

In other words, provided is a process of preparing a sorbent suitable for absorbing carbon dioxide from a mixture of gases, the sorbent comprising:
(A) polyalkyleneimine or an alkoxylated polyalkyleneimine; and
(B) an inorganic solid support,
   the polyalkyleneimine or alkoxylated polyalkyleneimine (A) being located on the inorganic solid support (B), and
   the process comprising:
loading the polyalkyleneimine or alkoxylated polyalkyleneimine (A) onto the inorganic solid support (B), the loading step comprising contacting (A) and (B) in the presence of aqueous solvent and then obtaining the sorbent product,
wherein the sorbent product comprises water in an amount of greater than 2 wt. % based on the total weight of the sorbent.

The sorbent prepared by the method may suitably be as defined above or according to any embodiment of the inventive sorbent herein.

In the above process, once A is loaded onto B, the resulting sorbent may be obtained by any conventional means, depending on the amount of water to be removed, such as by filtration and/or removal of water. The step of obtaining may thus include water removal. Water removal, if desired or required, may be performed by drying, such as using any conventional drying means, e.g. by air drying, centrifuge, under reduced pressure and/or with heating (e.g. in an oven such as a vacuum oven). According to the described embodiments above, the sorbent obtained comprises water in an amount of greater than 2 wt. % based on the total weight of the sorbent. This water content may be achieved by suitably controlling the drying conditions to avoid drying the sorbent to below this water content.

In another aspect, the present application provides a process for preparing a sorbent suitable for absorbing carbon dioxide from mixture of gases, the process comprising:
loading a polyalkyleneimine or alkoxylated polyalkyleneimine (A) onto an inorganic solid support (B), the loading step comprising contacting (A) and (B) in the presence of aqueous solvent to obtain a resulting loading mixture,
wherein the weight ratio of aqueous solvent to inorganic support (B) in the loading mixture does not exceed 5:1,
the method further comprising obtaining the sorbent from the loading mixture,
the sorbent comprising the polyalkyleneimine or alkoxylated polyalkyleneimine
(A) loaded onto the inorganic solid support (B).

Advantageously, this inventive process utilises aqueous solvent (e.g. water) as the solvent, and in relatively low amounts. In preferred embodiments, the weight ratio of aqueous solvent (e.g. water) to inorganic support (B) in the loading mixture does not exceed 3:1, or 2:1 or 1.5:1, 1:1, 0.5:1, or 0.2:1. Following the loading step, the sorbent may be obtained by filtration and/or removal of aqueous solvent. Aqueous solvent removal, if desired, may be performed by drying, such as by any conventional drying means, e.g. by air drying, centrifuge, under reduced pressure and/or with heating (e.g. in an oven such as a vacuum oven).

According to preferred embodiments of the above process, the sorbent obtained comprises water in an amount of greater than 2 wt. % based on the total weight of the sorbent. This water content may be achieved by suitably controlling the drying conditions, in particular to avoid drying the sorbent to below this water content.

In embodiments where the weight ratio of aqueous solvent to inorganic support (B) in the loading mixture is relatively low (e.g. 3:1 or less, such as 2:1 or less, or 1.5:1, or less or 1:1 or less, e.g. 0.5:1 or less) the sorbent may be obtained directly in suitably usable form, i.e. without the need for aqueous solvent removal steps, such as drying. In certain embodiments, the aqueous solvent content in the loading mixture is low enough that the inorganic support remains a powder throughout the loading step. The resulting sorbent may be further dried if necessary, although preferably is not dried to below 2 wt. % water based on the total weight of the sorbent.

The present invention also provides a sorbent obtained or obtainable according to any of the inventive methods described herein.

In another aspect, the present application provides a process for preparing a sorbent suitable for absorbing carbon dioxide from mixture of gases, the process comprising:
loading a polyalkyleneimine or alkoxylated polyalkyleneimine (A) onto an inorganic solid support (B), the loading step comprising contacting (A) and (B) in the presence of aqueous solvent to obtain a resulting loading mixture,
wherein the total weight of liquid in the loading mixture relative to the weight of inorganic support (B) in the loading mixture does not exceed 10:1,
the method further comprising obtaining the sorbent from the loading mixture,
the sorbent comprising the polyalkyleneimine or alkoxylated polyalkyleneimine
(A) loaded onto the inorganic solid support (B).

Desirably, in the above aspect, the weight ratio calculation is based on the total weight of the liquid component of the mixture relative to inorganic support (B). It will be appreciated that in typical embodiments, the liquid component of the loading mixture comprises, and in embodiments consists of, the aqueous solvent (e.g. water) combined with the PEI or alkoxylated PEI component (A). Such components typically combine to form a liquid solution. The inventors have found that it is practically advantageous to ensure the total liquid component relative to inorganic component is kept low. This is helpful for improving loading efficiency and can allow for the material to be more easily processed during the loading step, as well as reducing the practical demand to remove solvent after the loading step has completed. It can for instance help to ensure that the amount of excess liquid remaining is low, once any pores in the inorganic support (B) are filled with the liquid. In preferred embodiments, the weight ratio of liquid in the loading mixture to inorganic support (B) in the loading mixture does not exceed 6:1, or 4:1 or 3:1, 2:1, or 1:1, or 0.5:1. Following the loading step, the sorbent may be obtained by filtration and/or removal of aqueous solvent. Aqueous solvent removal, if desired, may be performed by drying, such as by any conventional drying means, e.g. by air drying, centrifuge, under reduced pressure and/or with heating (e.g. in an oven such as a vacuum oven).

According to preferred embodiments of the above process, the sorbent obtained comprises water in an amount of greater than 2 wt. % based on the total weight of the sorbent. This water content may be achieved by suitably controlling the drying conditions, in particular to avoid drying the sorbent to below this water content.

In embodiments where the weight ratio of the liquid in the loading mixture to inorganic support (B) in the loading mixture is relatively low (e.g. 6:1 or less, such as 4:1 or less, or 3:1, or less or 2:1 or less, e.g. 1:1 or less, such as 0.5:1 or less) the sorbent may be obtained directly in suitably usable form, i.e. without the need for aqueous solvent removal steps, such as drying. In certain embodiments, the liquid content in the loading mixture is low enough that the inorganic support remains a powder throughout the loading step. The resulting sorbent may be further dried, if necessary, although preferably is not dried to below 2 wt. % water based on the total weight of the sorbent.

The present invention also encompasses the use of a sorbent defined according to the present invention for capturing carbon dioxide, such as from a mixture of gases. The use in capturing carbon dioxide may include a subsequent step of desorbing the captured carbon dioxide. This has advantages in the context of CO₂ transport. This also has the benefit of then allowing the sorbent to be re-used to adsorb more CO₂, thus recycling the sorbent. Desorption may be suitably performed by heating. Products according to the invention have notably improved oxidative stability and so may be desirably recycled in this way multiple times, such as wherein each use cycle comprises both sorption and subsequent desorption of carbon dioxide.

The present sorbents contain polyalkyleneimine or an alkoxylated polyalkyleneimine (A) loaded onto an inorganic solid support (B). In embodiments where the inorganic solid support is porous, the step of loading may suitably include impregnating the solid support with the polymer. Where the terms impregnate, impregnated, or impregnating are referenced herein, these are thus references to loading the polymer onto a porous support.

### DESCRIPTION OF FIGURES

FIG. 1 is an image of a Greaves VS-1 laboratory mixer mixing a polyethyleneimine/water solution in a 10 L bucket.

FIG. 2 graphically illustrates nitrogen sorption isotherms of Silica 1 impregnated with PEI 1 (MW of 800) to give 30-50% w/w loadings.

FIG. 3 graphically illustrates N₂ sorption isotherms of Silica 1 impregnated with PEI 2 (MW of 5000 g/mol) to give 30-50% w/w loadings.

FIG. 4 graphically illustrates the CO₂ uptakes for Silica 1 impregnated with PEI 1 (MW of 800 g/mol) to give 30-50% w/w loadings.

FIG. 5 graphically illustrates the CO₂ uptakes for Silica 3 impregnated with PEI 1 (MW of 800 g/mol) to give 30-50% w/w loadings.

FIG. 6 graphically illustrates the CO₂ uptakes for Silica 3 impregnated with PEI 1 (MW of 800 g/mol) to give 30-50% w/w loadings.

FIG. 7 graphically illustrates the CO₂ uptakes for Silica 3 impregnated with PEI 2 (MW of 5000 g/mol) to give 30-50% w/w loadings.

FIG. 8 graphically compares the loss of CO₂ adsorption capacity during oxidation at 80° C. for Silica-PEIs with loadings of 30, 40 and 47% w/w using Silica 1 and PEI 2.

FIG. 9 graphically compares the loss of CO₂ adsorption capacity during oxidation at 70° C. for silica-PEIs with loadings of 40 and 47% w/w using Silica 1 and PEI 2.

FIG. 10 graphically illustrates the CO₂ uptake of Silica 1 impregnated with PEI 2, with vacuum drying to <2 and 4.5% w/w moisture.

FIG. 11 graphically illustrates a comparison of the loss of CO₂ adsorption capacity for Silica-PEIs (using Silica 1 and PEI 2, 47% w/w) with vacuum drying to <2 and 4.5 w/w moisture at 80° C. in air over 10 days.

FIG. 12a graphically illustrates the CO₂ uptake of Silica 1 impregnated with PEI 2 (50% w/w solution) to give a 47% w/w loading, with the overall water contents of 0.56, 4.53 and 9.53 g plus the 0.5 g of water from the PEI solution.

FIG. 12b graphically illustrates the CO₂ uptake of Silica 1 impregnated with PEI 1 (47% loading) prepared with the amounts of water used being zero, 0.5 g, 1 g, 2 g, 8 g, 10 g, 20 g and 40 g water of per g silica used.

FIG. 13 graphically illustrates CO₂ uptakes at 75° C. of Silica 1 impregnated with PEI 2 (50% w/w Solution) to give 30-50% w/w loadings.

FIG. 14 graphically illustrates CO₂ uptakes at 75° C. of Silica 2 impregnated with PEI 2 (50% w/w Solution) from 30-50% w/w.

FIG. 15 graphically illustrates CO₂ uptakes at 75° C. of Silica 3 impregnated with PEI 2 (50% w/w Solution) to give 20-43% w/w loadings.

FIG. 16 graphically illustrates CO₂ uptakes at 75° C. of Silica 4 impregnated with PEI 2 (50% w/w Solution) to give loadings of 30-50% w/w.

FIG. 17 graphically illustrates CO₂ uptakes at 75° C. of QuadraSil® MP (I) Silica impregnated with PEI 2 (50% w/w Solution) to give 10-35% w/w loadings.

FIG. 18 graphically illustrates CO₂ uptakes at 75° C. of Sylobead® SG W Silica impregnated with PEI 2 (50% w/w Solution) to give 5-20% w/w loadings.

### DETAILED DESCRIPTION OF THE INVENTION

The inventors have developed a new sorbent which is effective at absorbing carbon dioxide from a mixture of gases containing carbon dioxide, such as air or exhaust gases, such as from combustion of carbonaceous materials, e.g. fossil fuels. New and advantageous processes for preparing the sorbents have also been developed.

As described above, the invention provides a sorbent suitable for absorbing carbon dioxide from a mixture of gases, the sorbent comprising:
(A) polyalkyleneimine or an alkoxylated polyalkyleneimine; and
(B) an inorganic solid support,
the polyalkyleneimine or alkoxylated polyalkyleneimine (A) being located on the inorganic solid support (B),
wherein the sorbent comprises water in an amount of greater than 2 wt. % based on the total weight of the sorbent.

The sorbent may be conveniently prepared by an aqueous loading method as described herein. The described aqueous methods are procedurally simple, and because the liquid medium is aqueous, the method has a low environmental impact and is relatively safer than traditional manufacturing methods using organic solvents. The products claimed are therefore readily obtainable by simple and environmentally benign methods. In preferred processes described herein, the amount of aqueous solvent used is particularly low, providing both practical and efficiency benefits.

Traditionally, polyamines (including those employing polyethyleneimines and alkoxylated polyethyleneimines) are loaded onto inorganic solid supports such as silicas, using organic solvents, particularly polar organic solvents such as methanol. Methanol is a convenient solvent because these polyamine materials tend to have a high solubility in methanol, yet methanol has a relatively low boiling point and so may be readily removed after production. Methanol is however a carbon-containing compound and so is not an ideal choice of solvent from an environmental perspective in terms of possible fugitive emissions, especially when a typical purpose of the sorbent products is to deplete carbon (in the form of carbon dioxide) from air or waste combustion gases. Moreover, despite applying care and effort to remove the organic solvent afterwards, residual amounts of the organic solvent can still persist in the final sorbent product. This is not ideal, especially in cases where it is intended to recycle the sorbent (i.e. by desorption of CO₂ ready for re-adsorption), because typical sorbent recycling processes involve heating the sorbent, which can cause release of some residual methanol along with CO₂.

U.S. Pat. No. 10,751,689 B2, as described above, discloses a specific method for loading pentaethylenehexamine modified with propylene oxide onto a Sipernat® 50S (silica) support using an aqueous solvent system (e.g. example 2). However, water is not typically considered to be a desirable solvent for such a process because, whilst it is environmentally benign, it is more difficult to remove from the final material due to having a higher boiling point than conventional polar organic solvents. U.S. Pat. No. 10,751,689B2, in particular, teaches the skilled person that very high amounts of water are required in the loading mixture (upwards of 25:1 weight ratio of water to silica in the loading mixture according to Examples 1 and 2), requiring energy intensive processes to remove this water. Moreover, conventional wisdom in the field of solid CO₂ sorbents is that the presence of water or moisture in the product can cause diminished CO₂ adsorption capacity, for instance in the case of silica or zeolite adsorbents. This is recognised in U.S. Pat. No. 10,751,689 B2, column 2, line 24. Consistent with this, U.S. Pat. No. 10,751,689 B2 always teaches the skilled person to remove any water following its aqueous manufacturing processes by vacuum drying whilst heating (e.g. column 12, lines 58-67 and example 2).

Despite the above drawbacks of using organic solvent methods, and the environmental benefits of using water, organic solvent methods thus remain a prevalent route for manufacture of inorganic solid-supported polyamine sorbents in industry.

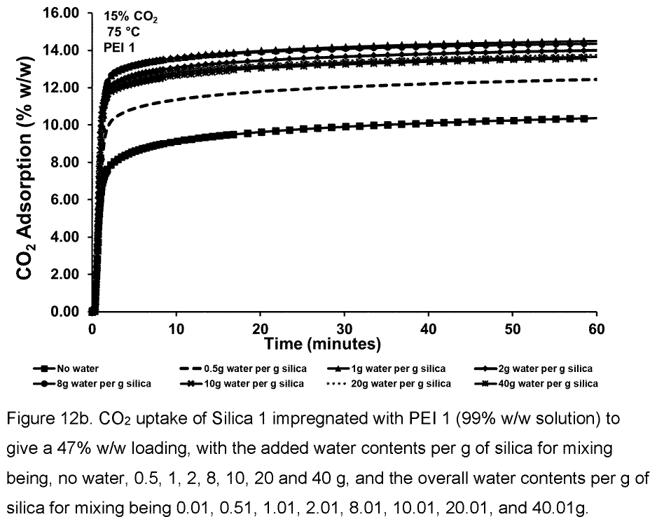

The inventors of the present invention have however discovered that, contrary to received wisdom, it is not necessary to remove all water following an aqueous polyalkyleneimine loading step in the context of inorganic solid supported sorbents to achieve desirable sorbent properties. Indeed, the inventors have found that by ensuring the water content of the sorbent product is greater than 2 wt. % the carbon dioxide absorption performance notably improves. In particular, as shown with reference to example 2 and FIG. 12 herein, sorbents of the invention having greater water content show similar CO₂ adsorption rates compared to reference samples containing less than 2 wt. % water, and with slightly higher adsorption capacity compared to the reference samples at first use (without wishing to be bound by theory, it is thought this may at least in part be due to some degradation of the polyamine in the reference sample due to the harsher drying conditions). Notably however, they simultaneously display vastly improved oxidative stability compared to a reference sample (which is an indication of the ability of the sorbent to continue to adsorb CO₂ over time). It is a surprising and highly advantageous realisation that products according to the invention are able to deliver such an improvement compared to reference examples containing lower amounts of, or no, water.

This is a significant contribution to this technical field because the inventive sorbents show adequate CO₂ adsorption rates and loading capacity and yet are highly stable compared to comparative sorbents and are readily and indeed preferably manufactured using environmentally benign aqueous processes. This is because the products can be conveniently obtained following such an aqueous process in a way that is less energy and time intensive compared to methods where complete removal of water was thought to be required and requiring relatively less care in handling the resulting products.

The sorbent according to the product claims of the present invention thus contains water in an amount of greater than 2 wt. % by weight of the sorbent. Desirably the sorbent may contain water in an amount of at least 2.5 wt. %, more desirably at least 3.0 wt. %, more desirably still at least 3.5 wt. %, suitably at least 4.0 wt. % relative to the total weight of the sorbent, such as around 4.5 wt. %. There is no particular upper limit for the amount of water that should be present in the sorbent. There may be, however, practical considerations to consider in including significant quantities of water with the sorbent. The sorbent may thus contain as much as 20 wt. % water or higher based on the weight of the sorbent. The sorbent in some embodiments, optionally including those above, may contain no more than 20 wt. % water based on the weight of the sorbent, such as no more than 15 wt. %, or no more than 10 wt. % or no more than 7.5 wt. %. For instance, the amount of water contained in the sorbent may be from 2.5 wt. % to 20 wt. %, for instance 3.0 wt. % to 10 wt. %, such as from 3.5 wt. % to 7.5 wt. % or from 4.0 wt. % 7.5 wt. %, such as 4.5 wt. %.

The invention also provides a process for manufacture of the described sorbents, the process including loading a polyalkyleneimine or alkoxylated polyalkyleneimine (A) onto an inorganic solid support (B), the loading comprising contacting the polyalkyleneimine or alkoxylated polyalkyleneimine (A) and an inorganic solid support (B) in the presence of an aqueous solvent (typically water) and then obtaining the sorbent.

The inventive process thus avoids the need for expensive and environmentally impactful organic solvents and avoids having to remove the organic solvents from the loaded inorganic solid support with the risk that residual organic solvents could remain in the sorbent. Organic solvents in the sorbent may have a deleterious effect on the carbon dioxide absorption and/or may lead to some of the residual solvent being later desorbed during optional CO₂ desorption processes, thus contaminating the desorbed CO₂ and leading to further carbon emissions. Organic solvents are thus preferably avoided entirely in the current methods, i.e. wherein the solvent is water.

In preferred embodiments of this process, contacting (A) and (B) in the presence of aqueous solvent provides a loading mixture and the weight ratio of aqueous solvent to inorganic support (B) in the loading mixture does not exceed 5:1. It will be appreciated that this is deliverable by controlling the amount of aqueous solvent provided with component (A) and/or (B). There may be relatively more aqueous solvent provided with component (A) or alternative with component (B), but where the total aqueous solvent (e.g. typically water) in the loading mixture preferably does not exceed the stated amount.

Optionally, the weight ratio of aqueous solvent to inorganic support (B) in the loading mixture does not exceed 3:1, optionally the weight ratio of aqueous solvent to inorganic support (B) in the loading mixture does not exceed 2:1. The weight ratio of aqueous solvent to inorganic support (B) in the loading mixture in preferred embodiments does not exceed 1:1. In such processes, the weight ratio of aqueous solvent to inorganic support (B) in the loading mixture is typically at least 0.2:1 or at least 0.5:1, such as at least 0.8:1, such as at least 1:1. The weight ratio of water to inorganic support (B) in the loading mixture may for instance be from 0.2:1 to 5:1, 0.2:1 to 3:1, 0.2:1 to 2:1 or 0.2:1 to 1.5:1. The weight ratio of water to inorganic support (B) in the loading mixture may for instance be from 0.5:1 to 5:1, 0.5:1 to 3:1, 0.5:1 to 2:1 or 0.5:1 to 1.5:1. It may for instance be from 1:1 to 5:1, 1:1 to 3:1, 1:1 to 2:1 or 1:1 to 1.5:1.

In preferred embodiments of the processes disclosed herein, the total volume of aqueous solvent in the loading step does not exceed 80% of the total pore volume of the inorganic support (B), e.g. it may not exceed 75% or 70%, or less, such as no more than 50% of the total pore volume of the inorganic support. In embodiments, the total volume of aqueous solvent used does not exceed 40%, 30%, 25%, 20%, 15% or 10% of the total pore volume of the inorganic support (B). The total volume of aqueous solvent in this context is intended to refer to the total amount of aqueous solvent contributed to the mixture when (A) and (B) are combined. By controlling the amount of aqueous solvent so the amount used is less than the pore volume of the support, it has advantageously been found possible to provide adequate loading of (A) onto (B) whilst ensuring that the inorganic support (B) remains a free-flowing powder throughout the process. This also keeps aqueous solvent use to a minimum, whilst avoiding the need to remove large amounts of water after the loading step. It will also be understood that the rate of addition of (A) to (B) or (B) to (A) as the case may be, can be adjusted by the skilled person to deliver suitable process properties, such as to avoid caking of (B) or excessive wetting of (B).

The inorganic support is typically provided in the form of particles. In such embodiments, depending on the aqueous solvent content, the loading mixture may have the consistency of a paste. In especially advantageous embodiments, the water content may be selected to ensure that the inorganic support in the loading mixture remains a powder throughout the loading step (i.e. without caking). It was surprising and advantageous to learn that the loading of polymer onto inorganic supports to provide CO₂ sorbents having excellent properties can be performed using such low amounts of water as solvent. Such embodiments thus avoid the need for organic solvents and for excessive amounts of water. This reduces both the need for water in the loading step (having advantageous practical and environmental consequences) and the time and energy required to remove water after loading, increasing the efficiency of the process.

In the above methods, once A is loaded onto B to form the sorbent, the resulting sorbent may be obtained by any conventional means. Depending on the final content of water in the product mixture, it may be desirable to remove some water to obtain the product. Water removal, if desired or required, may be performed by any conventional means, e.g. by filtration and/or drying, such as under reduced pressure and/or with heating (e.g. in an oven such as a vacuum oven).

Thus, the invention also therefore provides a process for manufacture of the described sorbents, the process including loading a polyalkyleneimine or alkoxylated polyalkyleneimine (A) onto an inorganic solid support (B), the loading comprising contacting the polyalkyleneimine or alkoxylated polyalkyleneimine (A) and an inorganic solid support (B) in the presence of an aqueous solvent to form a loading mixture (comprising the sorbent and aqueous solvent), the process further comprising removing water from the loading mixture, e.g. including by drying, to obtain the sorbent.

In a further aspect of the invention, the present application provides a process for preparing a sorbent suitable for absorbing carbon dioxide from mixture of gases, the process comprising:
loading a polyalkyleneimine or alkoxylated polyalkyleneimine (A) onto an inorganic solid support (B), the loading comprising contacting (A) and (B) in the presence of aqueous solvent to obtain a resulting loading mixture,
wherein the weight ratio of aqueous solvent to inorganic support (B) in the loading mixture does not exceed 5:1,
the method further comprising obtaining the sorbent from the loading mixture,
the sorbent obtained comprising the polyalkyleneimine or alkoxylated
polyalkyleneimine (A) loaded onto the inorganic solid support (B).

Advantageously, this inventive process utilises aqueous solvent (preferably water) as the solvent, and in relatively low amounts. It will be appreciated that the ratio of aqueous solvent in the loading mixture is controlled by controlling the amount of aqueous solvent provided with components (A) and/or (B). There may be relatively more aqueous solvent provided with component (A) or alternatively with component (B), but where the total aqueous solvent (e.g. typically water) in the loading mixture does not exceed the stated amount.

In preferred embodiments, the weight ratio of aqueous solvent to inorganic support (B) in the loading mixture does not exceed 3:1, or 2:1 or preferably 1.5:1. In such processes, the weight ratio of aqueous solvent to inorganic support (B) in the loading mixture is typically at least 0.2:1 or at least 0.5:1, such as at least 0.8:1, such as at least 1:1. The weight ratio of aqueous solvent (e.g. water) to inorganic support (B) in the loading mixture may for instance be from 0.2:1 to 5:1, 0.2:1 to 3:1, 0.2:1 to 2:1 or 0.2:1 to 1.5:1. The weight ratio of aqueous solvent to inorganic support (B) in the loading mixture may for instance be from 0.5:1 to 5:1, 0.5:1 to 3:1, 0.5:1 to 2:1 or 0.5:1 to 1.5:1. It may for instance be from 1:1 to 5:1, 1:1 to 3:1, 1:1 to 2:1 or 1:1 to 1.5:1.

In preferred embodiments, the total volume of aqueous solvent used does not exceed 80% of the total pore volume of the inorganic support, e.g. it may not exceed 75% or 70%, or less, such as no more than 50% of the total pore volume of the inorganic support. In embodiments, the total volume of aqueous solvent used does not exceed 40%, 30%, 25%, 20%, 15% or 10% of the total pore volume of the inorganic support (B). The total volume of aqueous solvent in this context is intended to refer to the total amount of aqueous solvent contributed to the mixture when (A) and (B) are combined. Typically, this refers to the total amount of water present. By controlling the amount of aqueous solvent so the amount used is less than the pore volume of the support, it has advantageously been found possible to provide adequate loading of (A) onto (B) whilst ensuring that the inorganic support (B) remains a free-flowing powder throughout the process. This also keeps aqueous solvent use to a minimum, whilst avoiding the need to remove large amounts of water after the loading step. It will also be understood that the rate of addition of (A) to (B) or (B) to (A), as the case may be, can be adjusted by the skilled person to deliver suitable process properties, such as to avoid caking of (B) or excessive wetting of (B).

The inorganic support is typically provided in the form of particles. In such embodiments, depending on the aqueous solvent content, the loading mixture may have the consistency of a paste. In especially advantageous embodiments, the water content may be selected to ensure that the inorganic support in the loading mixture remains a powder throughout the loading step (i.e. without caking). It was surprising and advantageous to learn that the loading of polymer onto inorganic supports to provide CO₂ sorbents having excellent properties can be performed using such low amounts of water as solvent. The present inventive method thus avoids the need for organic solvents and for excessive amounts of water. This reduces both the amount of water used in the loading step (having advantageous practical and environmental consequences) and the time and energy required to remove the water to desired levels after the loading step, increasing the efficiency of the process.

The sorbent prepared by the above process may suitably be as defined above or according to any embodiment of the inventive sorbent herein. Preferably, the sorbent obtained by the above process comprises water in an amount of greater than 2 wt. % based on the total weight of the sorbent.

In the above process, once A is loaded onto B to form the sorbent, the resulting sorbent may be obtained from the loading mixture by any conventional means, depending on the water content of the mixture and the desired final water content of the sorbent. For instance, if excess water is present in the loading mixture following the loading step, the sorbent may be obtained by filtration and/or removal of water. Water removal, if desired, may be performed by drying, such as by any conventional drying means, e.g. by air drying, centrifuge, under reduced pressure and/or with heating (e.g. in an oven such as a vacuum oven). According to preferred embodiments of the above process, the sorbent obtained comprises water in an amount of greater than 2 wt. % based on the total weight of the sorbent. This water content may be achieved by suitably controlling the drying conditions, in particular to avoid drying the sorbent to below this water content. However, in embodiments where the weight ratio of aqueous solvent to inorganic support (B) in the loading mixture is relatively low (e.g. 3:1 or less, such as 2:1 or less, or 1.5:1 or less) the sorbent may be obtained directly in suitably usable form, i.e. without the need for aqueous solvent removal steps, such as drying. In certain embodiments, the aqueous solvent content in the loading mixture is low enough that the inorganic support remains a powder throughout the loading step. The resulting sorbent may be further dried, if necessary, although preferably is not dried to below 2 wt. % water based on the total weight of the sorbent.

In another aspect of the invention, the present application provides a process for preparing a sorbent suitable for absorbing carbon dioxide from mixture of gases, the process comprising:
loading a polyalkyleneimine or alkoxylated polyalkyleneimine (A) onto an inorganic solid support (B), the loading step comprising contacting (A) and (B) in the presence of aqueous solvent to obtain a resulting loading mixture,
wherein the total weight of liquid in the loading mixture relative to the weight of inorganic support (B) in the loading mixture does not exceed 10:1,
the method further comprising obtaining the sorbent from the loading mixture,
the sorbent comprising the polyalkyleneimine or alkoxylated polyalkyleneimine
(A) loaded onto the inorganic solid support (B).

Desirably, in the above aspect, the weight ratio calculation is based on the total weight of the liquid component of the mixture relative to inorganic support (B). It will be appreciated that in typical embodiments, the liquid component of the loading mixture comprises, and in embodiments consists of, the aqueous solvent (e.g. water) combined with the PEI or alkoxylated PEI component (A). Such components typically combine to form a solution. The inventors have found that it is practically advantageous to ensure the total liquid component provided in the mixture is kept low. This is helpful for improving loading efficiency and can allow for the material to be more easily processed during the loading step, as well as reducing the practical demand to remove solvent after the loading step has completed. It can for instance help to ensure that the amount of excess liquid remaining is low, once any pores in the inorganic support (B) are filled with the liquid. In preferred embodiments, the weight ratio of liquid in the loading mixture to inorganic support (B) in the loading mixture does not exceed 6:1, or 4:1 or 3:1, 2:1, or 1:1, or 0.5:1. Following the loading step, the sorbent may be obtained by filtration and/or removal of aqueous solvent. Aqueous solvent removal, if desired, may be performed by drying, such as by any conventional drying means, e.g. by air drying, centrifuge, under reduced pressure and/or with heating (e.g. in an oven such as a vacuum oven).

According to preferred embodiments of the above process, the sorbent obtained comprises water in an amount of greater than 2 wt. % based on the total weight of the sorbent. This water content may be achieved by suitably controlling the drying conditions, in particular to avoid drying the sorbent to below this water content.

In embodiments where the weight ratio of the liquid in the loading mixture to inorganic support (B) in the loading mixture is relatively low (e.g. 6:1 or less, such as 4:1 or less, or 3:1, or less or 2:1 or less, e.g. 1:1 or less, such as 0.5:1 or less) the sorbent may be obtained directly in suitably usable form, i.e. without the need for aqueous solvent removal steps, such as drying. In certain embodiments, the liquid content in the loading mixture is low enough that the inorganic support remains a powder throughout the loading step. The resulting sorbent may be further dried, if necessary, although preferably is not dried to below 2 wt. % water based on the total weight of the sorbent.

In preferred embodiments, the weight ratio of liquid to inorganic support (B) in the loading mixture does not exceed 6:1, or 4:1 or preferably 3:1. In such processes, the weight ratio of liquid to inorganic support (B) in the loading mixture is typically at least 0.4:1 or at least 1:1, such as at least 1.6:1, such as at least 2:1. The weight ratio of liquid to inorganic support (B) in the loading mixture may for instance be from 0.4:1 to 10:1, 0.4:1 to 6:1, 0.4:1 to 4:1 or 0.4:1 to 3:1. The weight ratio of liquid to inorganic support (B) in the loading mixture may for instance be from 1:1 to 10:1, 1:1 to 6:1, 1:1 to 4:1 or 1:1 to 3:1. It may for instance be from 2:1 to 10:1, 2:1 to 6:1, 2:1 to 4:1 or 2:1 to 3:1.

In some embodiments, the total volume of liquid used does not exceed 80% of the total pore volume of the inorganic support, e.g. it may not exceed 75% or 70%, or less, such as no more than 50% of the total pore volume of the inorganic support. In embodiments, the total volume of aqueous solvent used does not exceed 40%, 30%, 25%, 20%, 15% or 10% of the total pore volume of the inorganic support (B). The total volume of liquid in this context is intended to refer to the total amount of liquid contributed to the mixture when components (A) and (B) are combined together with the aqueous solvent component. By controlling the amount of liquid so the amount used is less than the pore volume of the support, it has advantageously been found possible to provide adequate loading of (A) onto (B) whilst ensuring that the inorganic support (B) remains a free-flowing powder throughout the process. This also keeps aqueous solvent use to a minimum, whilst avoiding the need to remove large amounts of water after the loading step. It will also be understood that the rate of addition of (A) to (B) or (B) to (A), as the case may be, can be adjusted by the skilled person to deliver suitable process properties, such as to avoid caking of (B) or excessive wetting of (B).

In all methods of the invention described herein, it is desirable to avoid heating the sorbent at high temperatures when removing water, because this has been observed to lead to diminished CO₂ adsorption capacity, perhaps caused by degradation of the polyalkyleneimine/alkoxylated polyalkyleneimine. Typical temperatures for drying will generally depend on the size and type of dryer. For instance, a laboratory oven may use temperatures in excess of 50° C., for instance 80° C. to 100° C. or more. Nevertheless, industrial scale dryers may not operate at such high temperatures and instead effective drying temperatures may be considerably lower. Suitably the evaporation temperature should not be too high so as not to damage the sorbent. In embodiments, the temperature during the step of removing water from the product does not exceed 95 degrees C., such as 80 degrees C., of 75 degrees C., and in embodiments remains below 60 degrees C., e.g. remains below 50, 40 or 30 degrees C.

When drying under reduced pressure the exact pressure is not particularly important provided that effective drying is achieved (and in the case of the inventive products described herein, provided the product is not dried below 2 wt. % water). Typical reduced pressures may for instance be in the range of from 100 mbar to 500 mbar. As discussed herein, the so formed sorbent should not be excessively dried so as to remove all of the water.

The desired water content of the sorbent may thus be readily achieved by controlling the amount of water in the loading mixture and/or by controlling the water removal step after sorbent has been obtained, e.g. controlling drying conditions.

The sorbents of the invention, referring to the products per se, or the products provided by the disclosed methods of preparation, are typically particulate solids. The particular solid may for instance be in the form of a powder, e.g. a free flowing powder.

Typically, an aqueous solvent will comprise predominantly water. This may, for instance, be water or a liquid comprising water in an amount of at least 60% w/w with the remainder being a suitable cosolvent. In general, the aqueous solvent would comprise a much higher content of water.

Suitably, in any of the processes described herein, the aqueous solvent may comprise water in an amount of at least 90% w/w, preferably at least 95% w/w, more preferably at least 99% w/w, more preferably still at least 99.5% w/w and particularly preferably at least 99.9% w/w. Typically the solvent is water.

In any process described herein, the aqueous solvent may contain <50 ppm, suitably <30 ppm, suitably <20 ppm, suitably <10 ppm, of methanol, optionally <50 ppm, suitably <30 ppm, suitably <20 ppm, suitably <10 ppm of polar organic solvent, preferably <50 ppm, suitably <30 ppm, suitably <20 ppm, suitably <10 ppm of organic solvent, based on the weight of the aqueous solvent, preferably wherein there is an absence of methanol, or an absence of polar organic solvent, or an absence of any organic solvent.

These concentrations may be determined by thermal desorption with the volatiles released quantified by gas chromatography-mass spectrometry. The GC/MS used to calculate values according to the present disclosure was provided by Agilent. The system configuration was GC-MS Kopplung (7890/5975 or 7890/5977) with an Electron lonisation ion source and a single quadrupole spectrometer.

The aqueous solvent typically is water (i.e. consists of water) and in embodiments may be deionised water.

Any one or both of components A and B may be combined with aqueous solvent (e.g. water) before they are contacted together to form the sorbent. The polyalkyleneimine or alkoxylated polyalkyleneimine (A) to be combined with the inorganic support (B) may be provided neat, e.g. as anhydrous liquid, but preferably the polyalkyleneimine, or alkoxylated polyalkyleneimine may be provided as an aqueous solution. The amount of water may be adjusted by adding water, where necessary, to the aqueous solvent of the loading step. However, the water content should preferably be controlled to avoid using excessive amounts being used, as is required in certain embodiments described herein, e.g. those that require the weight ratio of water to inorganic solid in the loading mixture not exceed 5:1.

Component (A) in the processes/methods of the invention may be as defined according to any definition of (A) for any embodiment herein. Component (B) in the processes/methods of the invention may be as defined according to any definition of (B) for any embodiment herein. The sorbent obtained from the processes/methods of the invention may be as defined according to any definition of the sorbent for any embodiment herein.

Either one or both of components (A) and (B) may be combined with aqueous solvent prior to the step of contacting (A) and (B) in the loading step. In one embodiment, the inorganic solid support (B), preferably a silica, in dried form may be combined with aqueous solvent (e.g. water) to form an aqueous mixture containing the support. This may be provided in the form of a slurry dispersion or paste. In certain embodiments, the amount of water combined with (B) is kept low enough such that the resulting wetted material remains in powder form, e.g. a free flowing powder. The polyalkyleneimine or alkoxylated polyalkyleneimine (A) (which may be provided neat or as a solution in aqueous solvent) may then be mixed with the aqueous mixture containing inorganic solid support (B), wherein (B) is preferably a silica. In embodiments, the inorganic support is not combined with water prior to the loading step. In embodiments, (A) is provided in the form of a solution in aqueous solvent, preferably water.

In a preferred form of the inventive processes, the aqueous solvent is combined with the inorganic solid support (B) in an amount that does not exceed 2 g aqueous solvent per g of inorganic solid support (B). This enables the level of loading of the polyalkyleneimine or alkoxylated polyalkyleneimine (A) to be closer to the capacity of the inorganic solid support (B). In embodiments, the total amount of liquid in the loading mixture (i.e. the combined amount of aqueous solvent and PEI or alkoxylated PEI component (A)) may not exceed 4 g liquid per g of solid support, such as no more than 3 g per g.

In the methods of the invention, the polyalkyleneimine or alkoxylated polyalkyleneimine (A) may be provided in an aqueous solvent (preferably water) already pre-formed. Alternatively, the polyalkyleneimine or alkoxylated polyalkyleneimine (A) may be formed in the aqueous solvent in situ, e.g. by polymerisation of one or more precursors, and/or by alkoxylation of a polyalkyleneimine precursor, in the presence of the inorganic solid support (B). When (A) is formed in situ, it may be formed in the presence of (B), or the reaction mixture obtained following the reaction may be contacted with (B) to form the sorbent. Preferably, (A) is not prepared in situ, i.e. is supplied already pre-formed, e.g. pre-synthesised, or obtained from a commercial supplier. This allows for better quality control in the final material.

The synthesis of the polyalkyleneimine or alkoxylated polyalkyleneimine (A) should desirably avoid the use of methanol, or in embodiments any polar organic solvents, or in preferred embodiments any organic solvents. This will ensure that there is no organic solvent in the sorbent, which has advantages as explained above.

For the same reason, the polyalkyleneimine or alkoxylated polyalkyleneimine (A) component and the inorganic solid support (B) should preferably each be provided substantially free, e.g. entirely free, of such organic solvents, such as methanol and/or acetone, etc.

Preferably, the sorbent according to the present invention, or as produced by methods of the invention, contains less than 50 ppm methanol. It is preferred that the sorbent contain less than 50 ppm of any polar organic solvent, such as less than 50 ppm of any organic solvent. The above components may preferably be present in the sorbent in less than 30 ppm for instance less than 20 ppm and still more preferably less than 10 ppm. Most suitably the levels of the respective components should be lower still and generally the sorbent should be substantially free, e.g. entirely free, of the stated components, e.g. methanol, polar organic solvents, or any organic solvents. The level of polar organic solvent can be determined using Gas Chromatography/Mass Spectrometry, GC/MS provided by Agilent. The system configuration is GC-MS Kopplung (7890/5975 or 7890/5977) with an Electron Ionisation ion source and a single quadrupole spectrometer.

By organic solvents it is meant organic liquids that dissolve, or are miscible with, polyalkyleneimines or alkoxylated polyalkyleneimines. Generally, such organic solvents are polar organic solvents and examples include methanol, ethanol, isopropanol, acetone, DMF, or chloroform.

In all of the embodiments of the present invention, references to polyalkyleneimines may preferably refer to poly-C₂₋₁₂-alkyleneimines and most preferably polyethyleneimines, and references to alkoxylated polyalkyleneimines may preferably refer to alkoxylated poly-C₂₋₁₂-alkyleneimines, most preferably alkoxylated polyethyleneimines.

The sorbent according to the present invention (products per se or as produced by the described processes) may preferably be provided as particles. The sorbents may for instance be in the form of a powder, typically a free-flowing powder.

In the case of particles, the sorbent is not restricted by particle size and a wide range of particle sizes is contemplated, depending on the intended use. Very small particle sizes, for instance weight average particle sizes of below 0.1 mm are technically feasible and in other cases much larger weight average particle sizes of 5 mm or greater may be desirable. For many applications, there may be a preference for sorbents having a weight average particle size of at least 0.1 mm. The weight average particle size may often be larger than 0.1 mm and may even be as large as 5 mm. Thus, preferably the sorbent of the present invention has a weight average particle size of from 0.1 to 5 mm. Suitably the weight average particle size may be from 0.1 to 3 mm, especially from 0.1 to 2 mm.

Sorbents having weight average particle sizes of up to 5 mm may be suitable for fixed bed operations.

Particle size distributions were determined using a Malvern Mastersizer 2000 operating in dry dispersion mode with a Scirocco dispersion unit, micro volume tray and at 0.1 bar dispersion pressure. Particle size distributions were obtained from light scattering data using Mie theory and assuming a real refractive index of 1.46 and imaginary refractive index of 0.1. The average particle size determined from these distributions was the median particle size at 50% cumulative volume, which, for particles of uniform density, is equivalent to the median at 50% cumulative weight.

The sorbent may exist as a honeycomb structure.

In the products or methods described herein, the inorganic solid support (B) component may have a pore size from 0.2 to 3.0 ml per gram of the inorganic solid support (B), for instance from 0.5 to 2.5 ml per gram and preferably has a pore volume of from 0.7 to 2.0 ml per g. The inventors have found that this preferred range gives improved performance for carbon dioxide adsorption and good strength characteristics. Typically, very small pore volumes can under certain circumstances lead to inferior carbon dioxide absorption performance. This performance can be significantly improved by ensuring that the pore volume is not below 0.7 ml per g. The strength of the inorganic solid support (B) can in some cases be impaired where the pore volume is significantly larger, this is particularly so where the inorganic solid support (B) is required for multiple cycles, for instance in moving and fixed beds. Pore volumes of up to 2.0 ml per g can provide optimum strength for this purpose.

Examples of suitable materials as inorganic solid supports (B) include silica (such as fumed silica, precipitated silica, silica gel, or γ-silica), calcium sulfate, calcium silicate, zeolites, alumina (e.g. γ-alumina), titania, aluminosilicate or inorganic mineral. The material is preferably porous. Preferably the inorganic solid support is a silica, most preferably a silica gel or a precipitated silica.

Desirably the amount of polyalkyleneimine or alkoxylated polyalkyleneimine (A) loaded onto the inorganic solid support (B) may be as high as possible in order to provide the greatest CO₂ adsorption capacity and oxidative stability. The sorbent according to the present invention preferably has a loading of polyalkyleneimine or alkoxylated polyalkyleneimine (A) of at least 60 wt. % of the maximum loading capacity of the inorganic solid support (B). Preferably the sorbent loading of polyalkyleneimine or alkoxylated polyalkyleneimine (A) is at least 70 wt. % of the maximum loading capacity of the inorganic solid support (B), more preferably at least 80 wt. % and more preferably still at least 90 wt. %.

Maximum loading capacity for the inorganic solid support (B) may differ between different inorganic materials employed. Thus, by maximum loading capacity it is meant the maximum loading capacity of the particular material employed as the inorganic solid support (B).

In the products and methods of the invention, the sorbent may contain the PEI/alkoxylated PEI in an amount of from 10 wt. % to 70 wt. % relative to the total weight of the sorbent. Suitable loading of PEI/alkoxylated PEI on the sorbent is from 20 wt. % to 60 wt. % relative to the total weight of the sorbent. The sorbent according to the present invention preferably has a loading of polyalkyleneimine or alkoxylated polyalkyleneimine (A) of at least 20 wt. % relative to the total weight of the sorbent. Typically, the PEI/alkoxylated PEI loading does not exceed an amount of 60 wt. %, or more preferably 50 wt. % PEI/alkoxylated PEI relative to the total weight of the sorbent. In an embodiment, the sorbent contains the PEI/alkoxylated PEI in an amount of from 20 wt. % to 50 wt. % relative to the total weight of the sorbent, such as from 20-40 wt. %.

Loading levels of the polyalkyleneimine or alkoxylated polyalkyleneimine (A) by weight of inorganic solid support (B) may be at least 40% by weight based on the weight of the inorganic solid support (B), for instance from 40% to 60%, more preferably from 47 to 55% by weight based on the weight of the inorganic solid support (B).

Polyalkyleneimines, particularly as polyethyleneimines, are well known in the literature and available commercially, for instance the Lupasol® range of products available from BASF.

The polyalkyleneimines and/or alkoxylated polyalkyleneimine (A) may desirably have a weight average molecular weight (Mw) of from 300 to 20,000 g/mol, for instance from 300 to 15,000 g/mol, suitably from 300 to 10,000 g/mol, more suitably from 500 to 5000 g/mol. It is preferred that the polyalkyleneimine is a polyethyleneimine and the alkoxylated polyalkyleneimine is an alkoxylated polyethyleneimine. It is preferred that the polyalkyleneimine and/or alkoxylated polyalkyleneimine is branched, preferably based on branched polyethyleneimine. Typically, the degree of branching (DB) should be more than 50%, and preferably from 55 to 95%, preferably from 57 to 90% and more preferably from 60 to 80%.

The degree of branching (DB) is described in H. Frey et al., Acata Polym. 1997, 48, 30. The degree of branching DB is defined therein as

$$DB ( \% ) = ( T + Z ) / ( T + Z + L ) \times 100 ,$$

where
T is the average number of terminally bound monomeric units (primary amino groups),
Z is the average number of branching monomeric units (tertiary amino groups),
L is the average number of linearly bound monomeric units (secondary amino groups).

T, Z, and L can be determined via ¹³C-NMR in D₂O. Reference is made to T. St. Pierre & M. Geckle (1985) ¹³-NMR Analysis of Branched Polyethyleneimine, Journal of Macromolecular Science: Part A-Chemistry, 22:5-7, 877-887, DOI: 10.1080/00222338508056641.

Such branched polyethyleneimine may have range of molecular structures and one such example of a typical segment of a branched polyethyleneimine may be illustrated by the following exemplary structure:

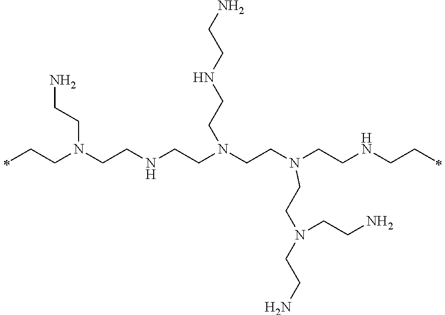

In this structure * denotes a continuance of the branched polyethyleneimine molecule.

Alkoxylated polyalkyleneimines, particularly alkoxylated polyethyleneimines, are preferred as the component (A) of the sorbent to the unmodified polyalkyleneimines. Alkoxylated polyalkyleneimines are known from the literature and can generally be produced by the alkoxylation of polyalkyleneimine using an alkylene oxide as alkoxylation agent. A typical description is given in Houben-Weyl, Methoden der organischen Chemie, 4.Ed., Vol. 14/2, p. 440 ff. (1963) and Vol. E 20, p. 1367 f. (1987).

Preferably alkoxylated polyethyleneimines (A) useful for the sorbents of the present invention are produced by alkoxylating polyethyleneimine with an alkylene oxide, such as propylene oxide, in a reaction mixture substantially in the absence of an organic polar solvent, such as methanol, ethanol, isopropanol or chloroform.

Typically, the alkoxylated polyalkyleneimine (A), preferably an alkoxylated polyethyleneimine, comprises alkoxyl moieties pendant from the main polyalkyleneimine or preferably polyethyleneimine structure. These alkoxyl moieties may be generally based on one, or mixtures of more than one C₂-C₁₂-alkylene oxide, desirably a C₂-C₁₀-alkylene oxide, more desirably a C₂-C₈-alkylene oxide, preferably ethylene oxide, propylene oxide or butylene oxide, more preferably propylene oxide or butylene oxide. The alkylene oxide may desirably be a mixture of alkylene oxides comprising one or more C₂-C₄ alkylene oxides and one or more C₈-C₁₂ alkylene oxides, preferably having a molar ratio of C₂-C₄ alkylene oxides to C₈-C₁₂ of from 2:1 to 20:1, more preferably from 5:1 to 10:1.

It is preferred that component (A) comprised in the sorbent (or used in the processes of forming the sorbent) is an alkoxylated polyalkyleneimine. Desirably the alkoxylated polyalkyleneimine (A) is obtainable by a process comprising the steps:
(a) providing a reaction mixture comprising
   (i) a polyalkyleneimine, and
   (ii) an alkylene oxide
(b) carrying out a reaction between the polyalkyleneimine (i) and the alkylene oxide (ii) at a temperature of at least 50° C.;
(c) optionally diluting the product of (b)
   wherein the mole ratio of alkylene oxide to NH of the polyalkyleneimine in the reaction mixture is from 0.1 to 0.35, and wherein the reaction mixture comprises <55% water, preferably <30% water, by weight based on the weight of the reaction mixture and the reaction mixture comprises <5%, preferably <1%, of a polar organic solvent, by weight based on the weight of the reaction mixture.

Preferably the alkoxylated polyalkyleneimine (A) is an alkoxylated polyethyleneimine and the polyalkyleneimine (i) in step (a) is a polyethyleneimine.

It is preferred that the alkoxylated polyalkyleneimine (A) in this embodiment is branched.

Preferably the polyalkyleneimine (i) in the reaction mixture in step (a) has a weight average molecular weight (MW) from 300 to 10,000 g/mol, preferably from 500 to 1500 g/mol.

The alkylene oxide (ii) employed in the reaction mixture of the step (a) is desirably a C₂-C₁₂ alkylene oxide, preferably ethylene oxide, propylene oxide or butylene oxide

The inventors have found that the sorbent comprising the alkoxylated polyalkyleneimine, particularly the alkoxylated polyethyleneimine, alkoxylated polyalkyleneimine being obtained by the above-described alkoxylation process unexpectedly exhibited particularly improved results for capturing carbon dioxide, by comparison to state-of-the-art alkoxylated polyalkyleneimines.

Without being limited to theory, the inventors believe that the alkoxylated polyalkyleneimine component of the sorbent being prepared in a composition by process with no or virtually no polar organic solvent (i.e. less than 5%, preferably less than 1%) with no or limited amount of water present (i.e. <55% water, preferably <30% water, based on the weight of the reaction mixture) that competing side reactions are avoided by comparison to alkoxylating the polyalkyleneimines using higher levels of sorbent. It is believed that this delivers a much-improved consumption of the alkylene oxide. Consequently, the composition comprising the alkoxylated polyalkyleneimine used to load onto the inorganic solid support (B) would tend to contain lower residual amounts of alkylene oxide. Employing the alkoxylated polyalkyleneimine having low levels of alkylene is advantageous to product safety in view of the high toxicity of alkylene oxide.

Therefore, more preferably the alkoxylated polyalkyleneimine containing composition used to load onto the inorganic solid support (B) comprises a residual content of alkylene of <150 ppm, preferably <50 ppm, more preferably <20 ppm, particularly preferably <10 ppm, most preferably <5 ppm, by weight based on the weight of the alkoxylated polyalkyleneimine in the composition. The level of alkylene oxide can be determined using Gas Chromatography/Mass Spectrometry, GC/MS provided by Agilent. The system configuration is GC-MS Kopplung (7890/5975 or 7890/5977) with an Electron Ionisation ion source and a Single Quadrupole Spectrometer.

It is preferred that the alkoxylated polyalkyleneimine composition used for preparing the sorbent is obtained in a process using a reaction mixture that comprises less than 3%, often less than 2%, preferably less than 1%, such as less than 7500 ppm, more preferably less than 5000 ppm, especially preferably less than 1000 ppm, less than 500 ppm, more especially preferred less than 100 ppm, particularly preferred less than 50 ppm polar organic solvent, by weight based on the weight of the reaction mixture. Most preferably the reaction mixture is free from any polar organic solvent. In addition, it is preferred that the aforesaid reaction mixture comprises water in amount less than 50%, normally less than 40%, typically less than 35% by weight of the reaction mixture. Preferably the amount of water in the reaction mixture should be less than 30% by weight of the reaction mixture. Desirably the amount of water should be less than 20% by weight of the reaction mixture. It is more desirable that the amount of water in the reaction mixture should be lower still, for instance less than 15%, preferably less than 12%, more preferably less than 10%, for instance less than 5% by weight based on the weight of the reaction mixture. More preferably still the amount of water present in the reaction mixture should be less than 2%, especially less than 1% by weight based on the weight of the reaction mixture. Especially preferably the reaction mixture should contain no water.

The reaction in step (b) would desirably be commenced by raising the temperature of the reaction mixture. Suitably the reaction in step (b) may be carried out at a temperature of at least 60° C., more suitably from 60° C. to 140° C., preferably from 75° C. to 135° C., more preferably from 80° C. to 130° C., still more preferably from 80° C. to 130° C.

Preferably the reaction in step (b) may be carried out at an elevated pressure, for instance greater than 1 bar, suitably in a pressurised reaction vessel. Preferably the reaction may be carried out at a pressure greater than 1.25 bar, preferably at a pressure of from 1.5 bar to 3 bar.

In the said process of obtaining alkoxylated polyalkyleneimine used in producing the sorbent the mole ratio of alkylene oxide to NH of the polyalkyleneimine, preferably polyethyleneimine, is from 0.1 to 0.35. Preferably the mole ratio of alkylene oxide to NH is from 0.15 to 0.32. The NH represents the amine number and is calculated by determination of the secondary amino groups and primary amino groups, where NH=(number of secondary amino groups)+(2×(number of primary amino groups)). NH is determined by titration of the respective polyalkyleneimine with trifluoromethanesulphonic acid.

The alkoxylated polyalkyleneimine, preferably an alkoxylated polyethyleneimine, preferably has an OH/NH molar ratio of from 0.20 to 0.35. The OH/NH ratio can be determined using 13C NMR.

The sorbent may include additional additives, for instance polyethylene glycol, surfactants, antioxidants, such as salicylic acid or phosphates. In some cases, polyethylene glycol or surfactants may improve the kinetics of carbon dioxide absorption. Antioxidants may potentially enhance oxidative stability. To prepare such products, such additives may be added to the solid inorganic support (B) before, simultaneous with, or subsequent to addition of the polyalkyleneimine/alkoxylated polyalkyleneimine (A). They may for instance be combined together with the polyalkyleneimine/alkoxylated polyalkyleneimine or these components may be added sequentially. Any additives are typically provided in the form of an aqueous solution. Desirably such additives may be included into the aqueous solvent used for preparing the sorbent.

The sorbent of the present invention can exhibit very effective carbon dioxide absorption for a significant period of time, including multiple adsorption/desorption cycles. This is particularly so when alkoxylated polyalkyleneimine, preferably alkoxylated polyethyleneimine, is used as the component (A) of the sorbent. Once the absorption capacity of the sorbent has diminished to below an acceptable level of absorption efficiency, the sorbent can be regenerated by removal of the polyalkyleneimine or alkoxylated polyalkyleneimine (A) from the inorganic solid support (B). This may be achieved, for instance by a washing process. The cleaned inorganic solid support (B) may then be reused by combining with fresh polyalkyleneimine or alkoxylated polyalkyleneimine (A), desirably using the synthesis technique described above.

The sorbent according to the present invention is intended for use in capturing carbon dioxide from a mixture of gases (containing carbon dioxide). Thus, described is the use (i.e. method of using the sorbents defined herein) in capturing carbon dioxide. This capture may be from a mixture of gases (containing carbon dioxide). The use may include a subsequent step of desorbing the captured carbon dioxide. Desorption may be suitably performed by heating. Products according to the invention have notably improved oxidative stability and so may be desirably recycled in this way, optionally multiple times. Thus, optionally, the use may therefore include one or more use cycles (e.g. 2, 3, 4, or 5, etc.), wherein each use cycle comprises both sorption and subsequent desorption of carbon dioxide.

Typically, the mixture of gases may include air and/or exhaust gases, for instance exhaust fumes produced from combustion of carbonaceous material. The exhaust gases may be produced by industrial processes, such as carbon fuel combustion processes, including power generating plants. Additionally, the mixture of gases may also include exhaust fumes produced from various other devices such as heat generating devices, including commercial and domestic boilers, or other devices such as motion generating devices, for instance combustion engines for vehicles.

The capturing of carbon dioxide from air typically means any air in the atmosphere and can also include air in enclosed spaces, for instance in buildings.

The following examples are intended as an illustration of the invention.

### EXAMPLES

### Description of Methods and Materials

### (i) Silicas

Mesoporous silicas synthesised from sodium silicate were prepared and are listed in Table 1.

TABLE 1
Summary of textural properties, bulk density, minimal
water and particle size distribution of the silicas.

| | | BET | | | Min | | | |
|---|---|---|---|---|---|---|---|---|
| | | Specific | | | amount | | | |
| | | Surface | Total Pore | Bulk | of | Dry dispersion size | | |
| | | Area | Volume | Density | water | (μm) | | |
| Silica | Form | (m²/g) | (cm³/g) | (g/cm³) | (g/g) | D(10) | D(50) | D(90) |
| 1 | Powder | 284^{c} | 1.75^{c} (93) | 0.24* | 1.95 | 64 | 116 | 191 |
| 2 | Powder | 306^{c} | 1.72^{c} (93) | 0.27* | 1.62 | 155 | 249 | 404 |
| 3 | Powder | 344^{c} | 1.01^{c} (87) | 0.39* | 1.05 | 215 | 340 | 484 |
| 4 | Powder | 422^{c} | 1.83^{c} (91) | 0.28* | 1.87 | 195 | 303 | 452 |

| | | | | | | |
|---|---|---|---|---|---|---|
| QuadraSil ® | Bead | 353^{c} | 0.60^{c} (80) | 0.53* | 0.87 | 250-710 |
| MP (I) | | | | | | μm >90%^{a} |
| Sylobead ® | Bead | 222^{c} | 0.54^{c} (85) | 0.45-0.58^{b} | 0.90 | >5.0 mm 2%^{b} |
| SG W 127 | | | | | | <3.15 mm 55%^{b} |
| | | | | | | <2.5 mm 7%^{b} |

Parenthesis denoted % mesoporosity.
^{a}= Johnson Matthey website.
^{b}= Grace website.
*= Bulk density by Mercury Intrusion Porosimetry.
^{c}= from N₂ sorption isotherms at −196° C.

The porous silicas used here were made by mixing sulphuric acid and sodium silicate under controlled conditions, washing the resulting amorphous solid, drying and milling. Means of controlling pore structure and particle size to achieve the desired outcomes are known to persons skilled in the art. Key process variables for the control of pore structure are time, temperature, pH, mixing conditions and reactant concentrations. Further relevant information can be found in, for example, The Chemistry of Silica: Solubility, Polymerization, Colloid and Surface Properties and Biochemistry of Silica (R. K. Iler, Wiley, 1979) and Sol-gel science, the physics and chemistry of sol-gel processing (Ed. by C. J. Brinker and G. W. Scherer, Academic Press, 1990).

(ii) PEIs and alkoxylated PEIs (A-PEI)

Polyethyleneimine (PEI) of average molar mass (Mw) 800 g/mol (PEI 1, 99%) and 5000 g/mol (PEI 2, 50%) g/mol were synthesised by BASF (Table 2A). Alkoxylated PEIs were prepared from anhydrous PEIs of different molecular weights (Mw) by reaction with different alkylene oxides either in the absence of solvent or in the presence of either methanol or water as solvent as indicated in Table 2B.

TABLE 2A
Properties of unmodified PEIs

| | Molecular | PEI | | |
|---|---|---|---|---|
| PEI | Weight (M_{w}) | Concentration | Density | Viscosity |
| Type | (g/mol) | (%) | (g/cm³) | (mPa · s) |
| PEI 1 | 800 | 99 | 1.03 | 5000 |
| PEI 2 | 5000 | 50 | 1.08 | 1100 |

Molecular/molar weight by Gel Permeation Chromatography. PEI Concentration by ISO3251. Bulk Density was determined by DIN51757 at 20° C. Viscosity by ISO2555.

The reference to molecular weight, average molecular mass or Mw used throughout this specification, including the Examples is a weight average molecular weight (Mw) with the units g/mol.

The synthesis methods for producing C A-PEI 1-2 and A-PEI 1-12 are set out below. The reference to amine number in each of the synthesis descriptions refers to the amine number of the polyethyleneimine before alkoxylation.

### C A-PEI 1

A 2 L glass flask with stirrer and a refluxing funnel was charged with 465 g polyethylenimine (PEI, Mw 800 g/mol, amine number 18.2 mmol/g) and 500 g methanol was added (300 rpm) while nitrogen was purged for 20 minutes while the mixture heated to 30° C. The temperature was kept within 30-35° C., 147.3 g propylene oxide (PO) was dosed over a period of 3 h. The mixture was stirred and mildly refluxed at 40° C. overnight. Then the methanol was removed within 45 minutes. Finally, the temperature was raised to 80° C. for another 45 Minutes and then 40 mbar of vacuum was applied for 15 minutes. The obtained yellowish mixture was quenched with nitrogen and cooled to room temperature (approximately 20° C.) and 615 g of a yellowish viscous liquid was obtained.

### C A-PEI 2

A 2 L glass flask with stirrer and a refluxing funnel was charged with 470 g polyethylenimine (PEI, Mw 1200 g/mol, amine number 17.9 mmol/g). 115 g water and 500 g methanol were added (300 rpm) and nitrogen was purged 20 minutes while the mixture was heated to 30° C. While the temperature was kept within 30-35° C., 151.5 g butylene oxide (BuO) was dosed over a period of 3 h. The mixture was stirred and mildly refluxed at 40° C. overnight. Then the methanol and water were removed while the temperature was raised to 100° C. (90 minutes) and kept for 45 minutes at 100° C. and then 40 mbar of vacuum was applied for 30 minutes. The obtained yellowish mixture was quenched with nitrogen and cooled to room temperature (approximately 20° C.). 623.9 g of a yellowish viscous liquid was obtained.

### Inventive A-PEI 1-12

### A-PEI 1

A 5 L stainless steel reactor with stirrer was charged with 2700 g polyethyleneimine (PEI) (Mw 800 g/mol, amine number 18.2 mmol/g). The reactor was evacuated (60 mbar) and purged with nitrogen 3 times while increasing the temperature to 110° C. The reactor was pressurized to 2 bar and dosage of propylene oxide (PO) was initiated with 125 g PO within 5 minutes. While stirring at 150 rpm a further 720 g PO whilst dosed over a period of 3.5 hours. The temperature was raised to 120° C. and stirred for another 3 hours. Then the reactor was cooled to 60° C. and depressurized. Finally, the reactor was treated for 20 minutes at 100 mbar and purged with nitrogen. 3551 g of a slightly yellowish viscous liquid was obtained.

### A-PEI 2

A 5 L stainless steel reactor with stirrer was charged with 2700 g PEI (Mw 800 g/mol, amine number 18.2 mmol/g). The reactor was evacuated (60 mbar) and purged with nitrogen 3 times while increasing the temperature to 100° C. The reactor was pressurized to 2 bar and dosage of propylene oxide was initiated with 112 g PO within 5 minutes. While stirring at 150 rpm a further 700 g PO was dosed over a period of 3 hours. The temperature was raised to 115° C. and stirred for another 3 hours. Then the reactor was cooled to 60° C. and depressurized. Finally, the reactor was treated for 20 minutes at 100 mbar and purged with nitrogen. 3409 g of a slightly yellowish viscous liquid was obtained.

### A-PEI 3

A 5 L stainless steel reactor with stirrer was charged with 2700 g PEI (Mw 800 g/mol, amine number 18.2 mmol/g). The reactor was evacuated (60 mbar) and purged with nitrogen 3 times while increasing the temperature to 100° C. The reactor was pressurized to 2 bar and dosage of butylene oxide (BuO) was initiated with 125 g BuO within 5 minutes. While stirring at 150 rpm a further 760 g BuO was dosed over a period of 3 hours. The temperature was raised to 115° C. and stirred for another 4 hours. Then the reactor was cooled to 60° C. and depressurized. Finally, the reactor was treated for 20 minutes at 100 mbar and purged with nitrogen. 3581 g of a clear viscous liquid was obtained.

### A-PEI 4

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar and dosage of propylene oxide (PO) was initiated with 117 g PO within 5 minutes. While stirring at 150 rpm a further 640 g PO was dosed over a period of 3 hours. The temperature was raised to 115° C. and stirred for another 3 hours. Then the reactor was cooled to 60° C. and depressurized. Finally, the reactor was treated for 20 minutes at 100 mbar and purged with nitrogen. 3452 g of a slightly yellowish viscous liquid was obtained.

### A-PEI 5

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 110° C. The reactor was pressurized to 2 bar and dosage of propylene oxide (PO) was initiated with 105 g PO within 5 minutes. While stirring at 150 rpm a further 400 g PO was dosed over a period of 2.5 hours. The temperature was raised to 115° C. and stirred for another 3 hours. Then the reactor was cooled to 60° C. and depressurized. Finally, the reactor was treated for 20 minutes at 100 mbar and purged with nitrogen. 3202 g of a slightly yellowish viscous liquid was obtained.

### A-PEI 6

A 5 L stainless steel reactor with stirrer was charged with 2700 g PEI (Mw 1200 g/mol, amine number 17.9 mmol/g) followed by 470 g water. The reactor was evacuated (60 mbar) and purged with nitrogen 3 times while increasing the temperature to 100° C. The reactor was pressurized to 2 bar and dosage of propylene oxide (PO) was initiated with 117 g PO within 5 minutes. While stirring at 150 rpm a further 640 g PO was dosed over a period of 3.5 hours. The temperature was raised to 115° C. and stirred for another 3 hours. Then the reactor was cooled to 60° C. and depressurized. Finally, the reactor was treated for 10 minutes at 100 mbar and purged with nitrogen. 3913 g of a slightly yellowish liquid was obtained.

### A-PEI 7

A 5 L stainless steel reactor with stirrer was charged with 2700 g PEI (Mw 5000 g/mol, amine number 17.7 mmol/g) followed by 385 g water. The reactor was evacuated (60 mbar) and purged with nitrogen 3 times while increasing the temperature to 100° C. The reactor was pressurized to 2 bar and dosage of butylene oxide (BuO) was initiated with 129 g BuO within 5 minutes. While stirring at 150 rpm a further 600 g BuO was dosed over a period of 3.5 hours. The temperature was raised to 120° C. and stirred for another 3 hours. Then the reactor was cooled to 60° C. and depressurized. Finally, the reactor was treated for 10 minutes at 100 mbar and purged with nitrogen. 3799 g of a clear liquid was obtained.

### A-PEI 8

A 5 L stainless steel reactor with stirrer was charged with 2700 g PEI (Mw 5000 g/mol, amine number 17.7 mmol/g). The reactor evacuated (60 mbar) and purged with nitrogen 3 times while increasing the temperature to 100° C. The reactor was pressurized to 2 bar and dosage of propylene oxide (PO) was initiated with 105 g PO within 5 minutes. While stirring at 150 rpm a further 200 g PO was dosed over a period of 1.5 hours. As a next step 380 g butylene oxide (BuO) was dosed within 2 h, then the temperature was raised to 120° C. and stirred for another 3 hours. Then the reactor was cooled to 60° C. and depressurized. Finally, the reactor was treated for 20 minutes at 100 mbar and purged with nitrogen. 3380 g of a clear liquid was obtained.

### A-PEI 9

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar after 291 g of 1-decene oxide (DO) was added. Dosage of propylene oxide (PO) was executed within 3.5 hours (648 g). The temperature was raised to 115° C. and stirred for another 3 hours. Then the reactor was cooled to 60° C. and depressurized. Finally, the reactor was treated for 20 minutes at 100 mbar and purged with nitrogen. 3636 g of a slightly yellowish viscous liquid was obtained.

### A-PEI 10

A 5 L stainless steel reactor with stirrer was charged with 2700 g PEI (Mw 1200 g/mol, amine number 17.9 mmol/g). The reactor was evacuated (60 mbar) and purged with nitrogen 3 times while increasing the temperature to 100° C. The reactor was pressurized to 2 bar after 201 g of 1-decenoxide (DO) was added. Dosage of butylene oxide (BuO) was executed within 3.5 hours (742 g). The temperature was raised to 115° C. and stirred for another 3 hours. Then the reactor was cooled to 60° C. and depressurized. Finally, the reactor was treated for 20 minutes at 100 mbar and purged with nitrogen. 3640 g of a clear viscous liquid was obtained.

### A-PEI 11

A 5 L stainless steel reactor with stirrer was charged with 2500 g PEI (Mw 800 g/mol, amine number 18.2 mmol/g) followed by 590 g water. The reactor was evacuated (60 mbar) and purged with nitrogen 3 times while increasing the temperature to 100° C. The reactor was pressurized to 2 bar and dosage of butylene oxide (BuO) was initiated with 152 g BuO within 5 minutes. While stirring at 150 rpm a further 700 g BuO was dosed over a period of 3 hours. The temperature was raised to 120° C. and stirred for another 3.5 hours. Then the reactor was cooled to 60° C. and depressurized. Finally, the reactor was treated for 10 minutes at 100 mbar and purged with nitrogen. 3933 g of a clear liquid was obtained.

### A-PEI 12

A 5 L stainless steel reactor with stirrer was charged with 2700 g PEI (Mw 5000 g/mol, amine number 17.7 mmol/g) and 375 g water. The reactor was evacuated (60 mbar) and purged with nitrogen 3 times while increasing the temperature to 100° C. The reactor was pressurized to 2 bar after 293 g of 1.2 dodecene oxide (DDO) was added. Dosage of propylene oxide (PO) was executed within 3.5 hours (462 g). The temperature was raised to 115° C. and stirred for another 3 hours. Then the reactor was cooled to 60° C. and depressurized. Finally, the reactor was treated for 10 minutes at 200 mbar and purged with nitrogen. 3826 g of a slightly yellowish viscous liquid was obtained.

TABLE 2B
Properties of the alkoxylated PEIs

| | | | AO/NH | | water | | | |
|---|---|---|---|---|---|---|---|---|
| | | | Sum AO | | content in | | | |
| Alkoxylated PEI | PEI - | | for | | reaction | Residual AO | | Amine-number |
| (A-PEI) | Mw | AO-type | mixtures | solvent | mixture | post reaction | | mmol NH/g |
| C A-PEI 1 | 800 | PO | 0.3/1 | MeOH | — | 2600 | ppm | 12.3 |
| C A-PEI 2 | 1200 | BuO | 0.25/1 | MeOH | 15% | 3200 | ppm | 12.9 |
| A-PEI 1 | 800 | PO | 0.3/1 | — | — | 3 | ppm | 12.5 |
| A-PEI 2 | 800 | PO | 0.25/1 | — | — | 3 | ppm | 13.7 |
| A-PEI 3 | 800 | BuO | 0.25/1 | — | — | 5 | ppm | 13.2 |
| A-PEI 4 | 1200 | PO | 0.27/1 | — | — | 5 | ppm | 13.5 |
| A-PEI 5 | 1200 | PO | 0.18/1 | — | — | 3 | ppm | 14.7 |
| A-PEI 6 | 1200 | PO | 0.27/1 | H2O | 12% | 9 | ppm | 13.3 |
| A-PEI 7 | 5000 | BuO | 0.22/1 | H2O | 10% | 8 | ppm | 13.8 |
| A-PEI 8 | 5000 | PO, BuO 1/1 | 0.22/1 | | — | | | 14.0 |
| A-PEI 9 | 1200 | PO, decen- | 0.27 | — | — | 10 | ppm | 13.7 |
| | | oxide 6/1 | | | | | | |
| A-PEI 10 | 1200 | BuO, decen- | 0.24 | — | — | 12 | ppm | 13.3 |
| | | oxide 8/1 | | | | | | |
| A-PEI 11 | 800 | BuO | 0.24 | H2O | 15% | 14 | ppm | 13.2 |
| A-PEI 12 | 5000 | PO, dodecen- | 0.20 | H2O | 10% | 8 | ppm | 13.8 |
| | | oxide 5/1 | | | | | | |

The reference to amine number in Table 2B refers to the amine number of the alkoxylated polyethyleneimine (Total amine number can be determined by DIN ISO 13716); AO—alkylene oxide; PO—propylene oxide; BuO—butylene oxide.

(iii) Silica-PEI and Silica-A-PEI 1 g Scale Synthesis by Sequential Wet Impregnation (Laboratory Scale)

In this section, for the purposes of illustrating the calculation for determining the loading of each of polyethyleneimine and alkoxylated polyethyleneimine onto silica, equation (1) is employed, where the term PEI Loading Percentage refers to the loading percentage for of either polyethyleneimine or alkoxylated polyethyleneimine respectively and the term WPEI refers to the weight of the respective polyethyleneimine and alkoxylated polyethyleneimine.

$$PEI Loading Percentage = \frac{WPEI}{WPEI + WSilica} \times 100 \qquad ( 1 )$$

For laboratory scale testing of 1 g quantities on a dry basis of silica PEI or A-PEI samples were prepared on a dry basis. The desirable amount of silica was combined with the required volume of PEI or A-PEI solution where deionised water was used to prepare the solution to achieve loadings of PEI or A-PEI in the range 10-50% by weight. Mixing was carried out in a 50 ml beaker with vigorous stirring for 5 minutes. The order of mixing of whether silica is slowly added to the PEI or A-PEI solution, or the solutions are added dropwise to the silica has no discernable effect.

Examples of weights used for 1 g laboratory scale samples using 50% w/w solution and PEI 2 and Silica 1 are given in Table 3. After mixing, the mixture was dried at 40° C. in a vacuum oven at 300 mbar for 24 hours using a Gallenkamp Vacuum Oven (SDI Group, UK). Where the volume of water was greater than 5 ml per g of silica, the samples were first left to dry in a fume hood for 3 days before vacuum drying. In all cases, vacuum drying was performed until solid powder samples contained 5-6% moisture, thus preparing inventive sorbents according to the claimed invention. The moisture content was determined using a Thermogravimetric Analyser (TGA) using a Q500, TA Instrument.

TABLE 3
Example of weights used to synthesize 1 g laboratory scale
sample of PEI-Silica using 50% w/w PEI 2 and Silica 1.

| PEI | | PEI | | Final Sample |
|---|---|---|---|---|
| Loading | | Solution | Silica 1 | Weight on dry |
| (%) | Water (g) | (g) | (g) | basis (g) |
| 30 | 1.07 (1.37) | 0.60 (0.30) | 0.70 | 1.00 |
| 35 | 0.92 (1.27) | 0.70 (0.35) | 0.65 | 1.00 |
| 40 | 0.77 (1.17) | 0.80 (0.40) | 0.60 | 1.00 |
| 43 | 0.68 (1.11) | 0.86 (0.43) | 0.57 | 1.00 |
| 45 | 0.62 (1.07) | 0.90 (0.45) | 0.55 | 1.00 |
| 47 | 0.56 (1.03) | 0.94 (0.47) | 0.53 | 1.00 |
| 50 | 0.48 (0.98) | 1.00 (0.50) | 0.50 | 1.00 |

Parenthesis denoted amount using 100% w/w PEI 1 (MW of 800).

### (iv) Silica-PEI Scale-Up to 40 kg by Sequential Wet Impregnation (Large-Scale Testing)

In this section the term PEI refers to synthesis of both polyethyleneimine loaded silica (Silica-PEI) and alkoxylated polyethyleneimine loaded silica (Silica-A-PEI).

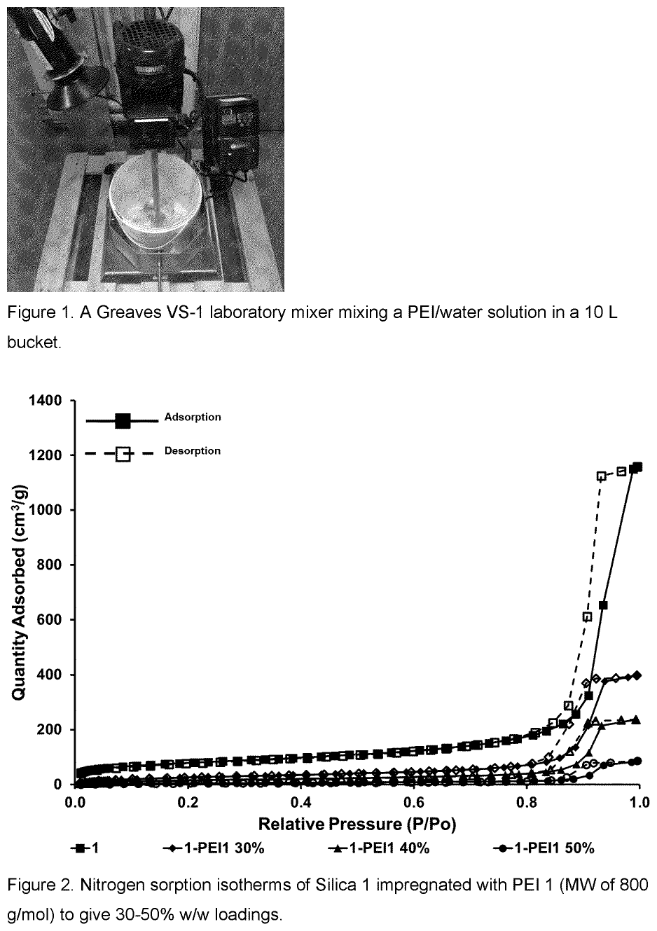

Scaling up to 40 kg silica impregnated PEI was prepared by sequential wet impregnation by making 5 Kg sub-batches and repeated 8 times. For example, to make a 47% w/w Silica-PEI on a dry basis using 50% w/w PEI 2, approximately 2.65 kg of Silica 1 was added to 2.80 kg of deionised water (5.15 Kg if 100% PEI solution is used in the loading step) into a 12 L plastic bucket and clamped into position on a Greaves VS-1 laboratory mixer and stirred at 300 rpm to ensure thorough mixing (FIG. 1). After 30 minutes, 4.70 kg of 50% w/w PEI 2 (2.35 Kg for 100% PEI) was added in small 0.50 Kg aliquots until all mixed in (Table 4). The resulting weight of water used was thus 5.15 g water (2.8 kg provided by the silica mixture and 2.35 g provided by the PEI solution) to 2.65 g, giving a water to silica weight ratio 1.94:1. Increasing the amount of PEI above 3.00 Kg (1.5 kg) resulted in an increase of rpm to 800 from 300. The entire mixture took approximately 4 hours to finish. All 5 Kg batches were placed into a fume cupboard for a week to vent excess water and leave agglomerated powder with 50% moisture. This was calculated from the weight of the plastic bucket used.

TABLE 4
Example of weights used to synthesise 5 Kg batches
of Silica-PEI (loadings 30-50% w/w) with Silica
1 and PEI 2 PEI-Silica with Silica 1.

| PEI | Water added and | PEI | | Final Sample |
|---|---|---|---|---|
| Loading | total weight of | Solution | Silica 1 | Dry Weight |
| (%) | water used (Kg) | (Kg) | (Kg) | (Kg) |
| 30 | 5.35 (6.85) | 3.00 | 3.50 | 5.00 |
| 35 | 4.60 (6.35) | 3.50 | 3.25 | 5.00 |
| 40 | 3.85 (5.85) | 4.00 | 3.00 | 5.00 |
| 43 | 3.40 (5.55) | 4.30 | 2.85 | 5.00 |
| 45 | 3.10 (5.35) | 4.50 | 2.75 | 5.00 |
| 47 | 2.80 (5.15) | 4.70 | 2.65 | 5.00 |
| 50 | 2.40 (4.90) | 5.00 | 2.50 | 5.00 |

Parenthesis denotes the overall weight of water used adding to half the weight of the 50% PEI solution. The water to silica weight ratios are thus all close to 1.95.

### (v) Drying of Silica-PEI 40 Kg Scale-Up

In this section the term PEI refers to synthesis of both polyethyleneimine loaded silica (Silica-PEI) and alkoxylated polyethyleneimine loaded silica (Silica-A-PEI).

Large scale vacuum drying was carried out using a Double Cone Vacuum Dryer. The material had a maximum allowable temperature of 45° C., so hot water was used as the heating medium. Approximately 20 Kg of Silica-PEI (50% moisture) was charged to the vacuum dryer, and the liquid-ring vacuum and hot-water boiler were started. The hot-water temperature was set to 70-95° C., and the dryer was run for 8 hours each day under these conditions. This procedure was followed until a final product moisture content of <2% was achieved (Table 5). As the water content of the sorbent at day 6 was lower than 2 wt. %, this product is not a sorbent as claimed in product claim 1.

TABLE 5
Summary of large-scale drying conditions.

| | Starting | Final | Material | Boiler | |
|---|---|---|---|---|---|
| | Moisture | moisture | Temperature | Temperature | Vacuum |
| Day | (%) | (%) | (° C.) | (° C.) | (mbar) |
| 1 | 50.0 | 34.3 | 28.2 | 70 | 150 |
| 2 | 34.3 | 26.8 | 37.4 | 75 | 150 |
| 3 | 26.8 | 16.4 | 30.3 | 90 | 150 |
| 4 | 16.4 | 10.5 | 39.5 | 87 | 150 |
| 5 | 10.5 | 4.5 | 40.7 | 95 | 150 |
| 6 | 4.5 | 1.9 | 42.3 | 95 | 150 |

### (vi) N₂ Sorption Isotherms

Textural characterisation of the raw silicas as received and silica-PEI and silica-A-PEI samples was carried out on a Micromeritics ASAP 2420 (Micromeritics Instrument Corp, USA) instrument. Approximately 250 mg of sample was weighed into a sample tube with filler rod. Before analysis, the samples were degassed to remove adsorbed moisture and other gases at 250° C. for 15 hours for as received silicas, and 50° C. for PEI impregnated silicas under high vacuum (<0.013 mbar). N₂ sorption isotherms was acquired from 0.01-0.99 relative pressure (P/Po) at −196° C. The specific surface area was calculated using the BET model from 0.05-0.20 P/Po giving a positive BET ‘C’ parameter. Meso/macro pore volume (up to 140 nm) and size distribution were determined by using the BJH model with Broekhoff-de-Boer thickness correction, and micropore volume by D-R model.

(vii) Determination of Absolute Silica-PEI/Silica-A-PEI loading

PEIA-PEI loading was determined by analysing the sample on a Thermogravimetric Analyser (TGA) (TGA Q500, TA Instruments Inc, New Castle, DE, USA). Silica and Silica-PEI/Silica-A-PEI samples (25-30 mg) were heated to 110° C. at a heating rate of 30° C./min in N₂ (1 bar, 100 mL/min) and held for 15 mins to remove moisture. After cooling to 80° C., the temperature was ramped to 800° C. at 30° C./min in air (1 bar, 100 mL/min) and then equilibrated at 800° C. for a further 15 mins. The weight loss between 200-600° C. was used to calculate Wt. % loading on a dry basis.

(viii) Carbon Dioxide (CO₂) Adsorption and Rates of Adsorption (kinetics)

The CO₂ adsorption capacity of the Silica-PEI/Silica-A-PEI samples was determined using a TGA (TGA Q500, TA Instruments Inc, New Castle, DE, USA). About 20-25 mg of the Silica, Silica-PEI/Silica-A-PEI impregnated samples were preheated to 110° C. for 30 mins to remove adsorbed moisture in N₂ (1 bar, 100 mL/min), then cooled to the optimum adsorption temperature and equilibrated. At this stage, the gas was switched to 15% CO₂ balanced by N₂ (1 bar, 100 mL/min) and the equilibration CO₂ capacity was acquired after being held for 60 minutes. For PEI 1 (MW 800) and PEI 2 (MW of 5000) an adsorption temperature of 75° C. was used. The optimum adsorption temperature for alkoxylated PEIs ranges from 25-70° C., depending on the degree of alkoxylation. The adsorption capacity on a dry basis was calculated by determining the weight change after the drying stage under 15% CO₂ gas. In addition to determining CO₂ adsorption capacity, adsorption kinetics was calculated by determining the time taken to reach 90 and 95% (t90 and t95) of equilibrium CO₂ capacity after 60 minutes. Furthermore, adsorption at 2 mins was recorded for comparison with fluidisation rates of adsorption.

### (ix) Stability/Oxidation Studies

The oxidation studies were carried out on Silica-PEI/Silica-A-PEI using a 60 L Lab Pro fan-assisted conventional oven (Scientific Laboratory Supplies, UK) at 80° C. for 10 days. Approximately 0.6 g of sample was weighed into a 50 ml beaker and spread evenly to ensure total exposure to air. On days 1, 3, 5, 7 and 10 approximately 50 mg was removed for further analysis quickly, to ensure little contact with humid lab conditions. The equilibrium CO₂ adsorption capacity (in 15% CO₂) of the oxidised samples after 60 minutes was acquired at the optimum temperature for the specific PEI/A-PEI, and then compared with the initial sample (or day 0) to determine the degree of oxidation.

### Results

### (i) Laboratory Synthesis of Silica-PEI/Silica-A-PEI and Amount of Water Used

Laboratory synthesis of Silica-PEI/Silica-A-PEI was used to develop a method that can be used for scale-up to 40 Kg batch preparation, and further scale-up to tonne production levels. For a 100% PEI/A-PEI, this is 1.95 g of deionized water for 1 g of Silica 1, or 78 Kg on a 40 Kg scale (Table 6).

As described herein, it may be procedurally advantageous to ensure the total water used does not exceed the total pore volume of the silica.

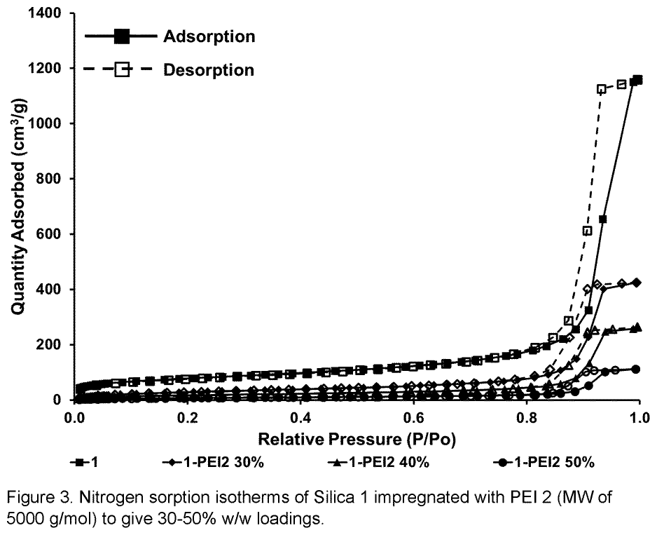

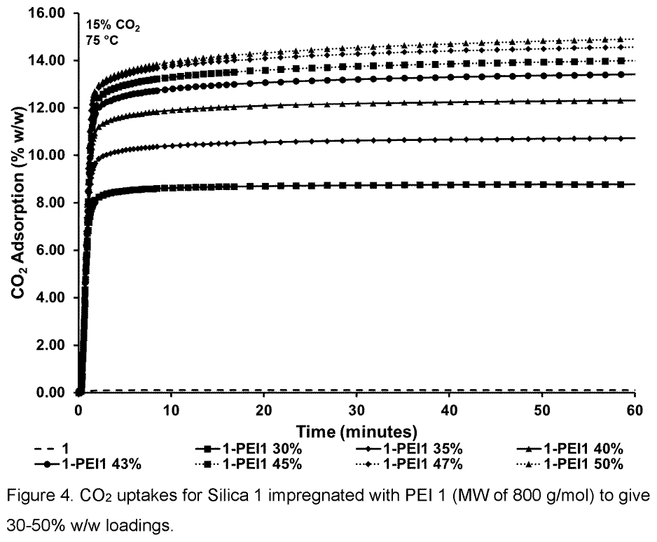

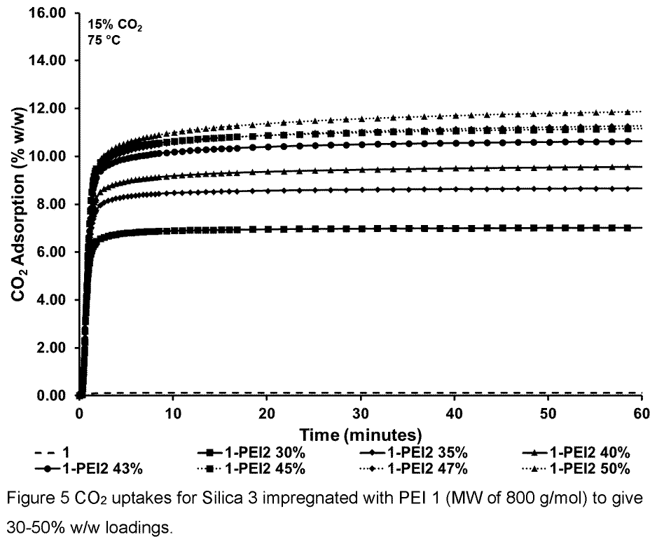

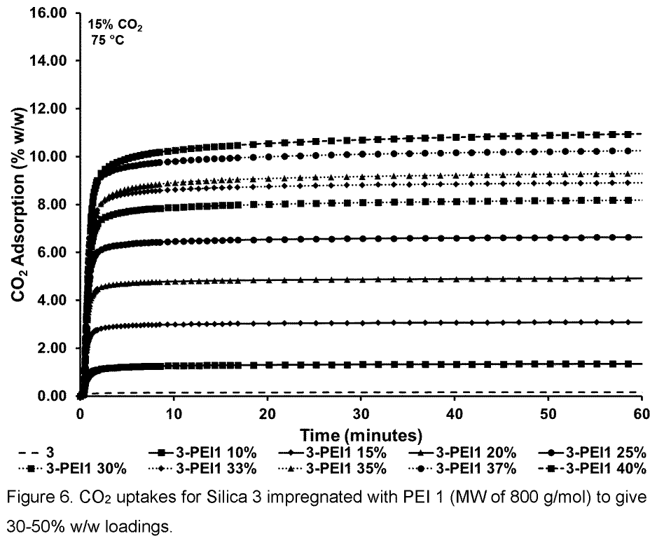

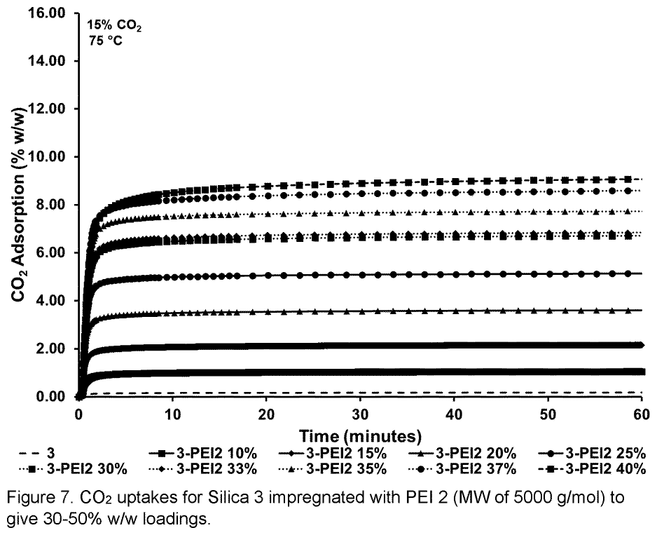

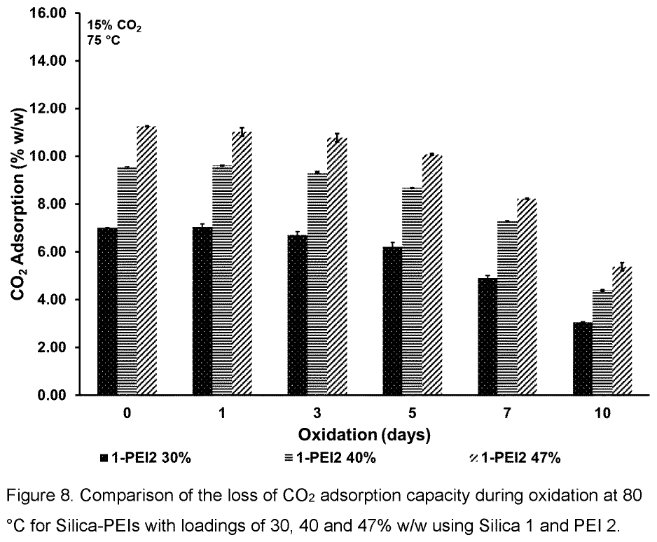

Silica 1 is predominantly mesoporous, and impregnation of PEI in Silica 1 occupies the mesopores, and narrow macropores, reducing the mesopore volume by 93 and 90% for PEI 1 and PEI 2 going from zero to a 50% loading, and ultimately N₂ adsorption at −196° C. (Table 7 and FIGS. 2 and 3). Particle agglomeration was observed to occur at 50 wt % loadings for both PEI 1 and PEI 2, and loadings of >50 wt. % gives an adhesive powder that has undesirable handling properties due to excessive agglomeration, rendering it not ideal for use as a commercial adsorbent. In desirable embodiments of the sorbents of the invention, the PEI thus does not exceed 50 wt. % on a dry mass basis relative to the total weight of the sorbent. Between 45-47% loading, 13% of the total pore volume remains for both PEI 1 and PEI 2, that we can suggest act as diffusional pores for CO₂ to reach the amine functional groups within the pores. PEI loadings of 50% and above bear PEI-Silica samples that are agglomerated, and with higher loadings very adhesive. At 50% loading, both PEI 1 and PEI impregnated samples have between 7-10% of total pore volume remaining, with this small pore volume rates of adsorption and desorption may be affected. Similar reductions in pore volume are seen for the other silicas.

TABLE 6
The amount of water to cover Silicas 1-4 on a g basis,

| | | Water Content | Water Content required |
|---|---|---|---|
| | Total Pore | for wetting | for 40% w/w PEI 2 per 1 |
| Silica | Volume(cm³/g) | (g/g) | g Silica-PEI |
| 1 | 1.75 | 1.95 | 0.56 (1.03) |
| 2 | 1.72 | 1.62 | 0.39 (0.86) |
| 3 | 1.01 | 1.05 | 0.09 (0.56) |
| 4 | 1.83 | 1.87 | 0.52 (0.99) |

Parenthesis denotes the weight of water equivalent to using 100% w/w PEI 1 solution.

TABLE 7
Effect on textural properties for impregnating Silica
1 with PEI 1 and PEI 2 for 30-50% w/w loadings.

| | | | | Total | Average |
|---|---|---|---|---|---|
| | BET | Micropore | Mesopore | Pore | Pore |
| | SA | Volume | Volume | Volume | Diameter |
| Sample | (m²/g) | (cm³/g) | (cm³/g) | (cm³/g) | (nm) |
| 1 | 284 | 0.11 | 1.63 | 1.75 | 24.7 |
| 1-PEI1 30% | 101 | 0.04 | 0.55 | 0.60 | 23.7 |
| 1-PEI1 35% | 77 | 0.03 | 0.43 | 0.47 | 24.4 |
| 1-PEI1 40% | 60 | 0.02 | 0.33 | 0.36 | 23.9 |
| 1-PEI1 43% | 53 | 0.02 | 0.31 | 0.33 | 25.3 |
| 1-PEI1 45% | 36 | 0.01 | 0.21 | 0.23 | 25.6 |
| 1-PEI1 47% | 33 | 0.01 | 0.21 | 0.22 | 26.5 |
| 1-PEI1 50% | 19 | 0.01 | 0.12 | 0.13 | 27.8 |
| 1-PEI2 30% | 110 | 0.04 | 0.60 | 0.64 | 23.1 |
| 1-PEI2 35% | 84 | 0.03 | 0.46 | 0.50 | 23.7 |
| 1-PEI2 40% | 65 | 0.02 | 0.36 | 0.40 | 24.4 |
| 1-PEI2 43% | 61 | 0.02 | 0.36 | 0.39 | 26.0 |
| 1-PEI2 45% | 39 | 0.01 | 0.21 | 0.24 | 24.19 |
| 1-PEI2 47% | 37 | 0.01 | 0.22 | 0.23 | 25.05 |
| 1-PEI2 50% | 28 | 0.01 | 0.16 | 0.17 | 24.32 |

BET SA = BET specific surface area from 0.05-0.20 relative pressure. Total pore volume = 0-140 nm using BJH model (Broekhoff-de-Boer thickness correction) + D-R model for microporosity. Average pore diameter = average pore diameter using 4 V/A (4 × total pore volume/specific surface area then converted to nm).

### (ii) CO₂ Uptake of Unmodified PEIs

TABLE 8
The effect on CO₂ uptake with increasing impregnation
of PEI on Silica 1 from 30-50% loading.

| | PEI | CO₂ | CO₂ | Rate of Adsorption^{d} | |
|---|---|---|---|---|---|
| | Loading^{a} | Uptake^{b} | Uptake^{c} | (minutes) | |
| Sample | (% w/w) | (% w/w) | (% w/w) | t90 | t95 |
| 1 | — | 0.1 | 0.1 | 2.9 | 6.1 |
| 1-PEI1 30% | 30.3 | 8.8 | 8.2 | 1.5 | 2.9 |
| 1-PEI1 35% | 35.3 | 10.7 | 9.8 | 1.8 | 4.6 |
| 1-PEI1 40% | 40.0 | 12.3 | 11.1 | 2.0 | 6.1 |
| 1-PEI1 43% | 43.4 | 13.4 | 11.9 | 2.4 | 8.7 |
| 1-PEI1 45% | 46.0 | 14.0 | 12.3 | 2.7 | 9.9 |
| 1-PEI1 47% | 47.1 | 14.6 | 12.7 | 3.3 | 12.0 |
| 1-PEI1 50% | 49.5 | 14.9 | 12.9 | 4.2 | 15.2 |
| 1-PEI2 30% | 30.9 | 7.0 | 6.5 | 1.6 | 3.1 |
| 1-PEI2 35% | 35.2 | 8.7 | 7.9 | 1.9 | 3.8 |
| 1-PEI2 40% | 40.9 | 9.6 | 8.4 | 2.5 | 7.1 |
| 1-PEI2 43% | 43.7 | 10.6 | 9.3 | 2.7 | 7.8 |
| 1-PEI2 45% | 45.7 | 11.2 | 9.6 | 3.2 | 9.5 |
| 1-PEI2 47% | 48.1 | 11.3 | 9.45 | 4.6 | 13. |
| 1-PEI2 50% | 51.12 | 11.9 | 9.7 | 6.0 | 16.8 |

^{a}= PEI loading from TGA in air 200-800° C.
^{b}= CO₂ uptake after 60 minutes at 75 ° C.
^{c}= CO₂ uptake after 2 minutes at 75° C.
^{d}= time taken to reach 90 and 95% (t90 and t95) capacity after 60 minutes.

TABLE 9
The effect on CO₂ uptake with increasing impregnation
of PEI 1 and 2 for Silica 3 for10-40% w/w loadings.

| | PEI | CO₂ | CO₂ | Rate of Adsorption^{d} | |
|---|---|---|---|---|---|
| | Loading^{a} | Uptake^{b} | Uptake^{c} | (minutes) | |
| Sample | (% w/w) | (% w/w) | (% w/w) | t90 | 195 |
| 3 | — | 0.2 | 0.1 | 11.7 | 26.6 |
| 3-PEI1 10% | 10.1 | 1.4 | 1.1 | 4.7 | 12. |
| 3-PEI1 15% | 15.2 | 3.1 | 2.8 | 1.9 | 5.1 |
| 3-PEI1 20% | 20.3 | 4.9 | 4.5 | 1.7 | 3.9 |
| 3-PEI1 25% | 24.9 | 6.6 | 6.0 | 1.7 | 4.1 |
| 3-PEI1 30% | 30.0 | 8.2 | 7.3 | 2.2 | 6.5 |
| 3-PEI1 33% | 33.1 | 8.9 | 7.9 | 2.2 | 5.3 |
| 3-PEI1 35% | 35.0 | 9.3 | 7.9 | 3.1 | 7.7 |
| 3-PEI1 37% | 37.3 | 10.3 | 9.1 | 2.5 | 7.9 |
| 3-PEI1 40% | 40.2 | 11.0 | 9.2 | 4.6 | 14.1 |
| 3-PEI2 10% | 10.3 | 1.1 | 0.9 | 4.7 | 12.7 |
| 3-PEI2 15% | 16.0 | 2.2 | 1.9 | 2.7 | 7.7 |
| 3-PEI2 20% | 19.5 | 3.6 | 3.2 | 2.0 | 5.4 |
| 3-PEI2 25% | 26.1 | 5.1 | 4.7 | 1.8 | 4.4 |
| 3-PEI2 30% | 30. | 6.71 | 5.8 | 2.2 | 5.8 |
| 3-PEI2 33% | 32.3 | 6.8 | 6.0 | 2.2 | 5.0 |
| 3-PEI2 35% | 36.0 | 7.7 | 6.9 | 2.1 | 4.7 |
| 3-PEI2 37% | 38.2 | 8.6 | 7.5 | 20. | 8.6 |
| 3-PEI2 40% | 40.3 | 9.01 | 7.3 | 5.1 | 12.9 |

### Example 1: Effect on PEI Loading on Oxidation Resistance on a Laboratory Scale

Silica 1 was sequentially wet impregnated with 30, 35, 40, 43, 45, 47 and 50% w/w PEI 2 on a dry basis to provide a comparison of oxidative stability where examples of the weights used are listed in Table 10.

TABLE 10
Example of weights used to synthesise 1 g laboratory scale
samples for PEI 2 on a dry basis using Silica 1.

| PEI 2 | | PEI | | Final |
|---|---|---|---|---|
| Loading | Water | Solution | Silica | Sample |
| (% w/w) | (g) | (g) | (g) | Weight (g) |
| 30 | 0.68 (1.37) | 0.60 | 0.70 | 1.00 |
| 35 | 0.63 (1.27) | 0.70 | 0.65 | 1.00 |
| 40 | 0.59 (1.17) | 0.80 | 0.60 | 1.00 |
| 43 | 0.56 (1.11) | 0.86 | 0.57 | 1.00 |
| 45 | 0.54 (1.07) | 0.90 | 0.55 | 1.00 |
| 47 | 0.52 (1.03) | 0.94 | 0.53 | 1.00 |
| 50 | 0.49 (0.98) | 1.00 | 0.50 | 1.00 |

Parenthesis denote the total weight of water used, adding that from the 50% PEI solution.

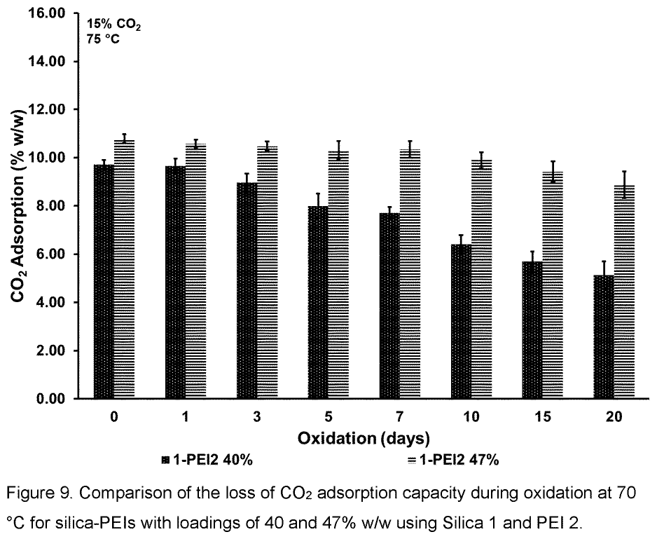

An oxidation study was carried out on the silica-PEI samples of increasing PEI loading using a fan assisted oven at 70 and 80° C., 20-25 mg samples were removed on 1, 3, 5, 7 and 10 days. CO₂ performance testing was carried out using a TGA, at an adsorption temperature of 75° C., in 15% CO₂ balanced by N₂ (1 bar, 100 ml/min) (FIG. 8).

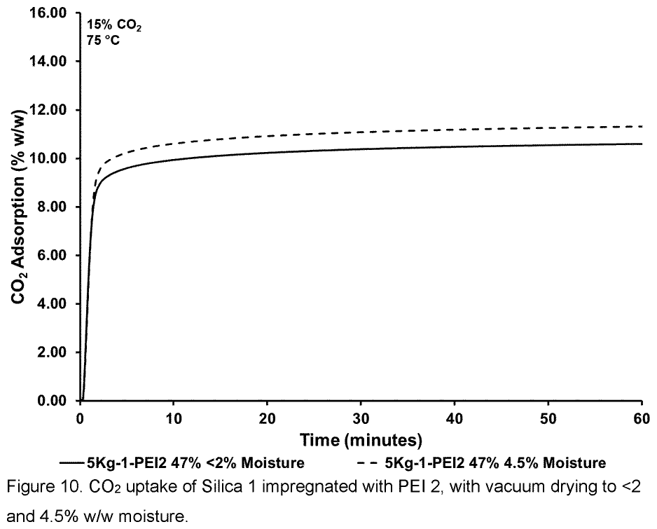

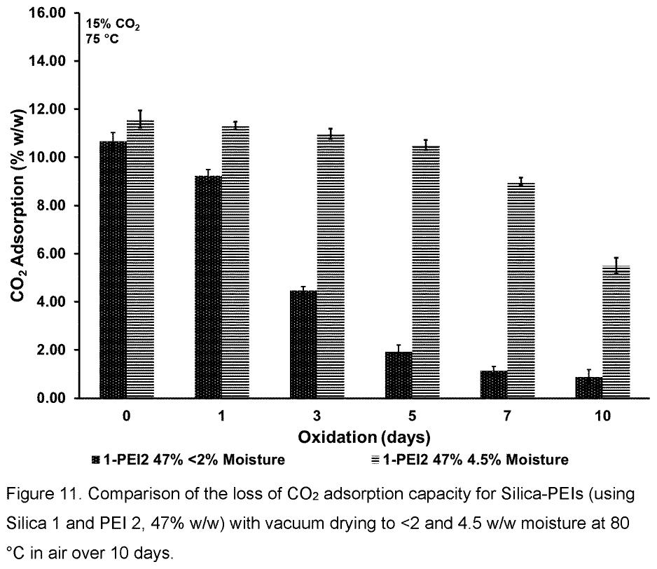

FIG. 8 indicates a 56% drop in CO₂ capacity after 10 days of oxidation at 80° C. with PEI 2 with a 30% w/w loading. Compared to a decrease of only 54% with a 40% w/w loading, and 52% for 47% w/w loading. FIG. 9 highlights the difference between 40 and 47% w/w loading at the lower oxidation temperature of 70° C. There was a 47% drop in CO₂ capacity after 20 days oxidation with PEI 2 with a 40% w/w loading compared to a drop of only 20% with a 47% w/w loading. The BET results in Table 11 confirm that the pore volume for air ingress drops as the loading is increased beyond 40% to reach the maximum achievable 50% w/w for Silica 1 being considered here.

TABLE 11
The effect on textural properties impregnating
Silica 1 with PEI 2 for 30-50% w/w loadings.

| | | | | Total | Average |
|---|---|---|---|---|---|
| | BET | Micropore | Mesopore | Pore | Pore |
| | SA | Volume | Volume | Volume | Diameter |
| Sample | (m²/g) | (cm³/g) | (cm³/g) | (cm³/g) | (nm) |
| 1-PEI2 30% | 110 | 0.04 | 0.60 | 0.64 | 23.1 |
| 1-PEI2 35% | 84 | 0.03 | 0.46 | 0.50 | 23.7 |
| 1-PEI2 40% | 65 | 0.02 | 0.36 | 0.40 | 24.4 |
| 1-PEI2 43% | 61 | 0.02 | 0.36 | 0.39 | 26.0 |
| 1-PEI2 45% | 39 | 0.01 | 0.21 | 0.24 | 24.2 |
| 1-PEI2 47% | 37 | 0.01 | 0.22 | 0.23 | 25.1 |
| 1-PEI2 50% | 28 | 0.01 | 0.16 | 0.17 | 24.3 |

BET SA = BET specific surface area from 0.05-0.20 relative pressure. Total pore volume = 0-140 nm using BJH model (Broekhoff-de-Boer thickness correction) + D-R model for microporosity. Average pore diameter = average pore diameter using 4 V/A (4 × total pore volume/specific surface area then converted to nm).

In conclusion, this example demonstrates it is highly desirable for PEI to occupy virtually all the pore volume at the highest possible loading to maximise oxidative stability by reducing the rate of air ingress through the increased PEI layer density.

### Example 2: Minimising the Duration of Vacuum Drying to Maintain PEI Integrity for Large-Scale Preparation

Silica 1 was sequentially wet impregnated with 47% w/w PEI 2 (Mw of 5000 g/mol). Two 5 Kg batches were prepared by pre-mixing Silica 1 with water. Approximately 2.65 Kg of Silica 1 was mixed with 2.80 Kg of water, using a Greaves VS-1 laboratory mixer at 300 rpm (FIG. 1). Next, 4.70 Kg of a 50% PEI 2 solution was added. Increasing the amount of PEI above 3.00 Kg (1.5 Kg) resulted in an increase of rpm to 800 from 300. The batches of silica-PEI were placed into a fume cupboard for a week to vent excess water and leave agglomerated powder with 50 w/w moisture, each batch weighing approximately 10 Kg.

Vacuum drying was carried out using a Double Cone Vacuum Dryer. The material had a maximum allowable temperature of 45° C., so hot water was used as the heating medium. Approximately 5 Kg of Silica-PEI (50% moisture) was charged to the vacuum dryer, and the liquid-ring vacuum and hot-water boiler were started. The hot-water temperature was set to 70-95° C., and the dryer was run for 8 hours each day under these conditions. This procedure was followed at daily increments to obtain products with varying degrees of water content, down to <2% w/w (Table 12). The sample obtained after 6 days having a water content of 1.9 wt % (i.e. less than 2 wt %) as determined by TGA is thus a reference sample not according to the sorbents claimed in product claim 1.

TABLE 12
Summary of drying conditions.

| | Start | Final | Material | Boiler | |
|---|---|---|---|---|---|
| | Moisture % | moisture % | Temperature | Temperature | Vacuum |
| Day | (w/w) | (w/w) | (° C.) | (° C.) | (mbar) |
| 1 | 50.0 | 34.3 | 28.2 | 70 | 150 |
| 2 | 34.3 | 26.8 | 37.4 | 75 | 150 |
| 3 | 26.8 | 16.4 | 30.3 | 90 | 150 |
| 4 | 16.4 | 10.5 | 39.5 | 87 | 150 |
| 5 | 10.5 | 4.5 | 40.7 | 95 | 150 |
| 6 | 4.5 | 1.9 | 42.3 | 95 | 150 |

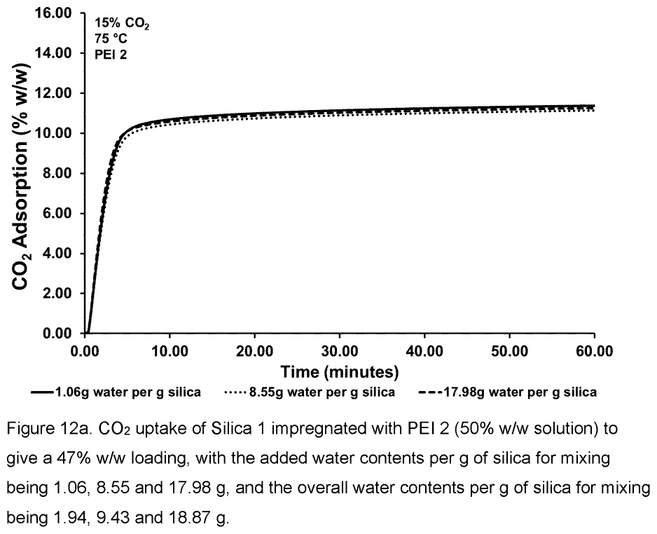

The CO₂ adsorption capacity of the 5 Kg Silica 1PEI 2 samples was determined using a TGA as described in Methods and Materials. For PEI 2 (5000 g/mol molecular weight), An optimum adsorption temperature of 75° C. was used. (FIG. 11). In addition to determining CO₂ adsorption capacity on a dry basis, adsorption kinetics was calculated by determining the time taken to reach 90 and 95% (t90 and t95) of equilibrium CO₂ capacity after 60 minutes (Table 13). Oxidation stability was determined at 80° C. as described under Methods and Materials where 20-25 mg removed over 10 days (FIG. 12) and analysed on the TGA for change in CO₂ uptake performance.

TABLE 13
Summary of the extent of vacuum drying on the adsorbent performance
at a 5 Kg scale for Silica 1 impregnated with PEI 2.

| | CO₂ | Rate of Adsorption | |
|---|---|---|---|
| | Uptake | (minutes) | |
| Sample | (% w/w) | t90 | t95 |
| 5 Kg-1-PEI2 47% <2% Moisture | 10.6 | 4.5 | 13.4 |
| 5 Kg-1-PEI2 47% 4.5% Moisture | 11.3 | 4.6 | 13.7 |

In conclusion, this example demonstrates that a sorbent sample according to the invention containing 4.5% moisture was able to significantly improved performance properties compared to a reference sample dried to less than 2 wt % moisture. Although adsorption rates (kinetics) are similar between samples, equilibrium CO₂ capacity reduced by 5.0% for the reference sample. It is speculated that this may be due to degradation of the polyethyleneimine caused by the prolonged heating. Moreover, in addition, oxidative stability for the reference sample reduced dramatically, with only 8% uptake remaining according to the test conditions, compared to 47% CO₂ uptake remaining for a sample of the invention (4.5 w/w moisture).

This demonstrates a significant and unexpected advantage of the inventive sorbents claimed in product claim 1 over the current state of the art in this technical field.

### Example 3: The Effect of Low to High Water Weight on the Wet PEI Impregnation on Silica

The impact of the weight or volume of deionised water on the sequential wet impregnation of PEI with silica was investigated on a 1 g scale (dry basis) using Silica 1, using both PEI 1 and 2. A PEI loading of 47% w/w was selected as the optimum loading for Silica 1 when considering CO₂ uptake and rates of adsorption for this PEI. The weights of water and PEI used for preparing the mixtures of Silica 1 with PEIs 1 and 2 are listed in Tables 14a and b.

TABLE 14a
Summary of laboratory scale weights of water, Silica
1 with PEI 2 to provide a 47% loaded PEI-Silica.

| | | |
|---|---|---|
| Amount of | Weight of | Weight of |
| Water (g) | PEI (g) | Silica (g) |

| | | | |
|---|---|---|---|
| 1.06 | (1.94) | 0.94 | 0.53 |
| 8.55 | (9.43) | 0.94 | 0.53 |
| 17.98 | (19.87) | 0.94 | 0.53 |

Parenthesis denote the total weight of water used per g of silica, adding that from the 50% PEI solution.

TABLE 14b
Summary of laboratory scale weights of water, Silica
1 with PEI 1 to provide a 47% loaded PEI-Silica.

| | | |
|---|---|---|
| Amount of | Weight of | Weight of |
| Water (g) | PEI (g) | Silica (g) |

| | | | |
|---|---|---|---|
| 0 | (0.01) | 0.47 | 0.53 |
| 0.5 | (0.51) | 0.47 | 0.53 |
| 1 | (1.01) | 0.47 | 0.53 |
| 2 | (2.01) | 0.47 | 0.53 |
| 8 | (8.01) | 0.47 | 0.53 |
| 10 | (10.01) | 0.47 | 0.53 |
| 20 | (20.01) | 0.47 | 0.53 |
| 40 | (40.01) | 0.47 | 0.53 |

Parenthesis denote the total weight of water used per g of silica, adding that from the 99% PEI solution.

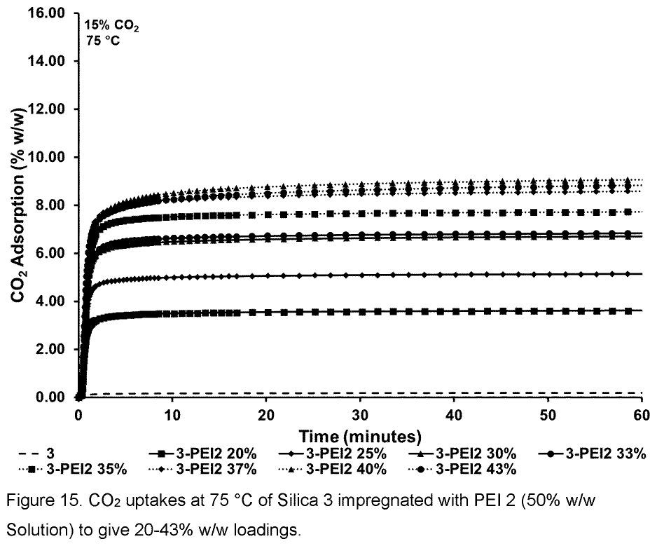

Equilibration CO₂ adsorption capacities of the Silica 1-PEI 2 samples and Silica 1-PEI 1 samples are presented in FIGS. 15a and b. The weight change under 15% CO₂ gas was determined on a dry basis, and adsorption kinetics was calculated by determining the time taken to reach 90 and 95% (t90 and t95) of equilibrium CO₂ capacity after 60 minutes (Tables 15a and b). The results indicate that there is no reduction in the CO₂ adsorption capacity as the weights of water added from 10 g to 1 g, where 1 g of water corresponds to 2 g overall including the water added in the 50% PEI solution, and when the 1 g of water in the 50% PEI solution is included, For PEI 1 which can be used neat, as little as 0.5 g of water gives an acceptable performance. The reduced performance for the neat sample indicates the benefit of including some added water in the solution.

TABLE 15a
Summary of the effect of the quantity of water on the adsorbent
performance of Silica 1(1 g) impregnated with PEI 2 (50%
w/w solution, MW of 5000) to give 47% w/w loading.

| Sample and the added | PEI | CO₂ | Rate of Adsorption^{c} | |
|---|---|---|---|---|
| water used for mixing | Loading^{a} | Uptake^{b} | (minutes) | |
| per g of silica | (% w/w) | (% w/w) | t90 | t95 |
| 1-PEI2 47% + 1.06 g H₂O | 48.1 | 11.4 | 5.5 | 12.9 |
| 1-PEI2 47% + 8.55 g H₂O | 48.0 | 11.1 | 5.6 | 13.70 |
| 1-PEI2 47% + 17.98 g H₂O | 48.1 | 11.3 | 5.1 | 12.8 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

TABLE 15b
Summary of the effect of the quantity of water
on the adsorbent performance of silica 1(1 g)
impregnated with PEI1 to give 47% w/w loading.

| Sample and the added | PEI | CO₂ | Rate of Adsorption^{c} | |
|---|---|---|---|---|
| water used for mixing | Loading^{a} | Uptake^{b} | (minutes) | |
| per g of silica | (% w/w) | (% w/w) | t90 | t95 |
| 1-PEI1 47% + 0 g H₂O | 48.5 | 10.4 | 13.3 | 27.7 |
| 1-PEI1 47% + 0.5 g H₂O | 48.6 | 12.5 | 7.9 | 2′.o |
| 1-PEI1 47% + 1 g H₂O | 48.5 | 14.5 | 3.9 | 13.8 |
| 1-PEI1 47% + 2 g H₂O | 48.2 | 14.1 | 4.6 | 15.2 |
| 1-PEI1 47% + 8 g H₂O | 48.1 | 14.4 | 3.0 | 11.1 |
| 1-PEI1 47% + 10 g H₂O | 48.3 | 13.7 | 4.0 | 13.9 |
| 1-PEI1 47% + 20 g H₂O | 48.1 | 13.8 | 4.4 | 15.0 |
| 1-PEI1 47% + 40 g H₂O | 48 | 13.6 | 5.2 | 16.6 |

In conclusion, this example demonstrates using lower levels of deionised water for PEI-Silica preparation does not in fact detrimentally affect adsorbent performance in terms of rate and uptake. For scale-up to 5 Kg or larger quantities, the amount of water saved by reducing the water content is in line with the methods herein is considerable, especially when accounting for the cost and time to dry the sample to remove the excess water down to a level of typically 5% w/w moisture in the silica-PEI product.

### Example 4: The Effect of Silica Particle Size on the Wet Sequential PEI Impregnation

The impact of the particle size (or dry dispersion size) on the sequential wet impregnation of PEI with Silica was investigated on a 1 g scale (dry basis) using silcas 1-4 and commercially sourced silicas spanning 0.1-3 mm D(50) particle size (Table 1). The higher molecular weight and viscosity PEI, 2 (50% w/w solution), and the minimal amount of deionised water associated with the bulk density and particle size of the specific silica. Samples were prepared at various loadings to determine investigate the effect of loading for each silica.

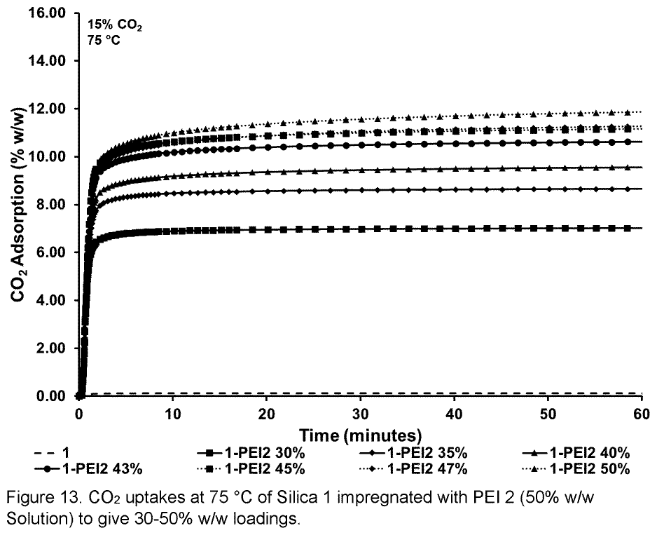

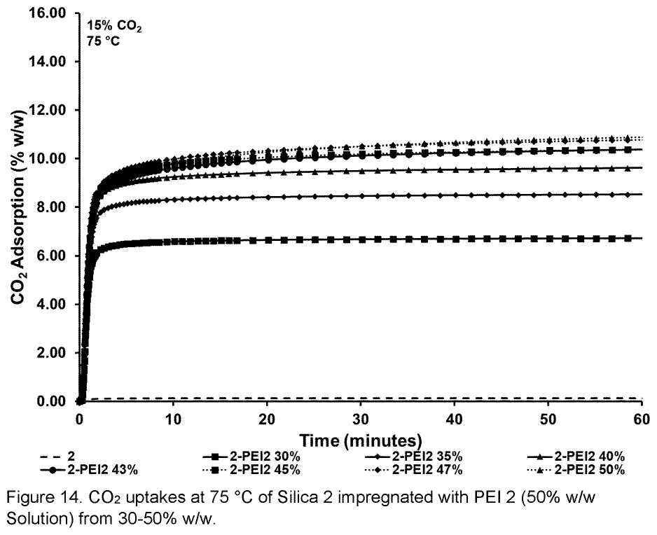

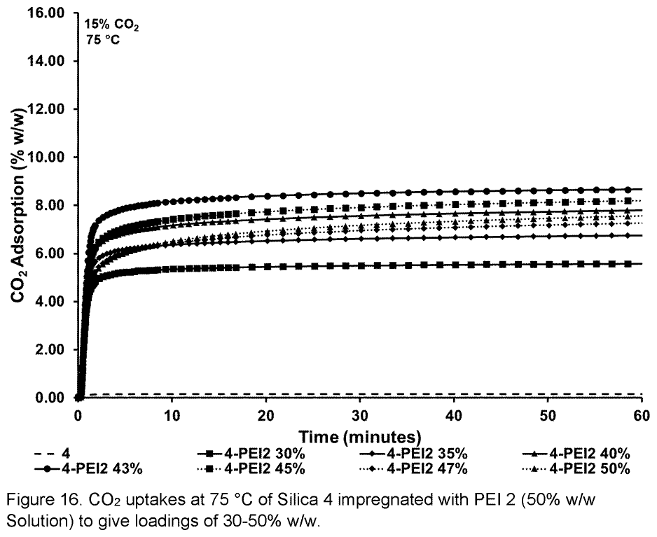

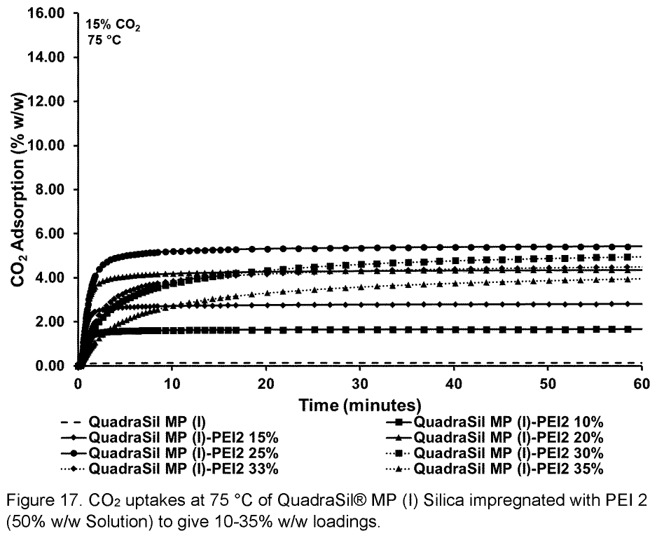

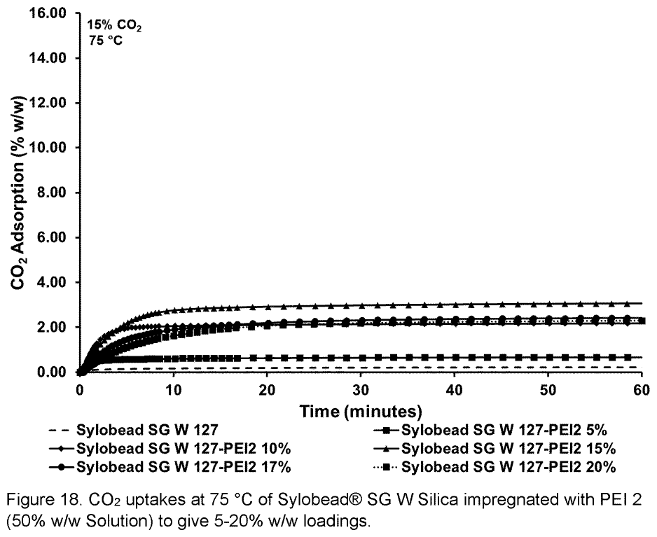

Equilibration CO₂ adsorption capacities of the Silica 1-2 and commercial silicas impregnated with PEI 2 (50% w/w solution) by TGA as described under Methods and Materials. The results for the six silicas investigated (Table 1) are presented in FIGS. 13-18 and Tables 16-21.

TABLE 16
Summary of the adsorbent performance of Silica 1 impregnated
with PEI 2 (50% w/w solution, MW of 5000).

| | | |
|---|---|---|
| PEI | CO₂ | Rate of Adsorption^{c} |
| Loading^{a} | Uptake^{b} | (minutes) |

| Sample | (% w/w) | (% w/w) | t90 | t95 |
|---|---|---|---|---|
| 1 | — | 0.1 | 2.9 | 6.1 |
| 1-PEI2 30% | 30.9 | 7.0 | 1.6 | 315 |
| 1-PEI2 35% | 35.2 | 8.7 | 1.9 | 3.8 |
| 1-PEI2 40% | 40.8 | 9.6 | 2.5 | 7.1 |
| 1-PEI2 43% | 43.7 | 10.6 | 2.7 | 7.8 |
| 1-PEI2 45% | 45.7 | 11.2 | 3.2 | 9.5 |
| 1-PEI2 47% | 48.1 | 11.3 | 4.6 | 13.7 |
| 1-PEI2 50% | 51.1 | 11.9 | 6/0 | 16.78 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

TABLE 17
Summary of the adsorbent performance of Silica 2 impregnated
with PEI 2 (50% w/w solution, MW of 5000).

| | | |
|---|---|---|
| PEI | CO₂ | Rate of Adsorption^{c} |
| Loading^{a} | Uptake^{b} | (minutes) |

| Sample | (% w/w) | (% w/w) | t90 | t95 |
|---|---|---|---|---|
| 2 | — | 0.1 | 3.9 | 7.9 |
| 2-PEI2 30% | 29.2 | 6.7 | 1.7 | 3.4 |
| 2-PEI2 35% | 35.4 | 8.5 | 2.0 | 4.5 |
| 2-PEI2 40% | 40.3 | 9.6 | 2.6 | 7.2 |
| 2-PEI2 43% | 43.8 | 10.4 | 6.1 | 16.6 |
| 2-PEI2 45% | 45.6 | 10.4 | 4.4 | 12.2 |
| 2-PEI2 47% | 48/0 | 10.8 | 6.3 | 17.1 |
| 2-PEI2 50% | 49.9 | 10.9 | 9.8 | 22.8 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

TABLE 18
Summary of the adsorbent performance of Silica 3 impregnated
with PEI 2 (50% w/w solution, MW of 5000).

| | | |
|---|---|---|
| PEI | CO₂ | Rate of Adsorption^{c} |
| Loading^{a} | Uptake^{b} | (minutes) |

| Sample | (% w/w) | (% w/w) | t90 | t95 |
|---|---|---|---|---|
| 3 | — | 0.2 | 11.7 | 26.6 |
| 3-PEI2 20% | 19.5 | 3.6 | 2.0 | 5.4 |
| 3-PEI2 25% | 26.1 | 5.1 | 1.8 | 4.4 |
| 3-PEI2 30% | 30.8 | 6.7 | 2.2 | 5.8 |
| 3-PEI2 33% | 32.3 | 6.8 | 2.2 | 5.0 |
| 3-PEI2 35% | 36.0 | 7.7 | 2.1 | 4.7 |
| 3-PEI2 37% | 38.2 | 8.6 | 2.89 | 8.6 |
| 3-PEI2 40% | 40.3 | 9.01 | 5.1 | 12.9 |
| 3-PEI2 43% | 43.4 | 8.8 | 5.1 | 14.6 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

TABLE 19
Summary of the adsorbent performance of Silica 4 impregnated
with PEI 2 (50% w/w solution, MW of 5000).

| | | |
|---|---|---|
| PEI | CO₂ | Rate of Adsorption^{c} |
| Loading^{a} | Uptake^{b} | (minutes) |

| Sample | (% w/w) | (% w/w) | t90 | t95 |
|---|---|---|---|---|
| 4 | — | 0.16 | 2.2 | 3.9 |
| 4-PEI2 30% | 31.2 | 5.6 | 2.6 | 7.5 |
| 4-PEI2 35% | 34.6 | 6.8 | 3.9 | 12.6 |
| 4-PEI2 40% | 40.3 | 7.8 | 7.0 | 19.1 |
| 4-PEI2 43% | 44.0 | 8.7 | 4.3 | 12.2 |
| 4-PEI2 45% | 46.1 | 8.2 | 9.1 | 22.5 |
| 4-PEI2 47% | 48.0 | 7.3 | 12.0 | 26.8 |
| 4-PEI2 50% | 50.5 | 7.6 | 16.5 | 31.1 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

TABLE 20
Summary of the adsorbent performance of QuadraSil ®
MP (I) Silica impregnated with PEI 2 (50% w/w solution).

| | PEI | | | |
|---|---|---|---|---|
| | Load- | CO₂ | | |
| | ing^{a} | Uptake^{b} | Rate of Adsorption^{c} | |
| | (% | (% | (minutes) | |
| Sample | w/w) | w/w) | t90 | t95 |
| QuadraSil ® MP (I) | — | 0.1 | 3.1 | 6.6 |
| QuadraSil ® MP (I)-PEI2 10% | 10.5 | 1.7 | 12.0 | 4.7 |
| QuadraSil ® MP (I)-PEI2 15% | 16.4 | 2.8 | 2.23 | 5.6 |
| QuadraSil ® MP (I)-PEI2 20% | 21.1 | 4.4 | 3.2 | 7.4 |
| QuadraSil ® MP (I)-PEI2 25% | 26.0 | 5.4 | 3.9 | 8.7 |
| QuadraSil ® MP (I)-PEI2 30% | 29.8 | 5.0 | 23.8 | 35.3 |
| QuadraSil ® MP (I)-PEI2 33% | 32.9 | 4.5 | 14.6 | 26.5 |
| QuadraSil ® MP (I)-PEI2 35% | 35.98 | 3.96 | 29.01 | 40.60 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes

TABLE 21
Summary of the adsorbent performance of Sylobead ®
SG W Silica impregnated with PEI 2 (50% w/w solution).

| | PEI | | | |
|---|---|---|---|---|
| | Load- | CO₂ | | |
| | ing^{a} | Uptake^{b} | Rate of Adsorption^{c} | |
| | (% | (% | (minutes) | |
| Sample | w/w) | w/w) | t90 | t95 |
| Sylobead ® SG W | — | 0.2 | 27.3 | 40.1 |
| Sylobead ® SG W-PEI2 5% | 5.2 | 0.7 | 9.0 | 20.6 |
| Sylobead ® SG W-PEI2 10% | 10.8 | 2.2 | 5.2 | 11.6 |
| Sylobead ® SG W-PEI2 15% | 14.8 | 3.1 | 10.0 | 19.3 |
| Sylobead ® SG W-PEI2 17% | 17.6 | 2.4 | 19.1 | 28.2 |
| Sylobead ® SG W-PEI2 20% | 20.6 | 2.3 | 20.0 | 29.4 |

^{a}= PEI loading from TGA in air 200-800° C.
^{b}= CO₂ uptake after 60 minutes at 75° C.
^{c}= time taken to reach 90 and 95% (t90 and t95) capacity after 60 minutes.

These examples demonstrate that an aqueous impregnation method can be used to impregnate silicas, spanning a particle size range from below 0.1 mm up to 3.0 mm, using minimal amounts of water, and that sorbents retaining a moisture level of greater than 2 wt % relative to the weight of the sorbent display similar CO₂ absorbance efficiency compared to samples having a lower water content, but with improved oxidation stability. The difference in the optimum PEI loadings and the kinetics of adsorption for each of the silicas is dictated by total pore volume (or mesoporosity) coupled to the particle size range.

### Example 5—CO₂ Absorption Characteristics of Silica-alkoxylated PEI (Silica-A-PEI)

Silica-A-PEI were prepared using comparative alkoxylated PEIs (Comp. A-PEI 1-2) and alkoxylated PEI (A-PEI 1-12) shown in Table 2B and Silicas 1-3 shown in Table 1 using procedures (iii) and (iv) employing drying procedure (v) under Description of Methods and Materials. The Silica-A-PEI sorbent materials used thus had a water content of around 5-6% wt. C A-PEI 1 and C A-PEI 2 were prepared using a methanolic preparation process as described above and so the comparative aspect is the method of synthesis relative to the aqueous methods of the invention described herein.

The loading of the alkoxylated PEI onto the silica was determined using the technique of (vii); the carbon dioxide absorption and rates of absorption and (kinetics) was established according to (viii); and stability/oxidation studies were carried out according to (ix) of the Description of Methods and Materials. The results are shown in Table 22 and Table 23.

TABLE 22
Silica 1 loaded with 46.7-49.5% alkoxylated PEI

| | | | CO₂ | CO₂ | CO₂ |
|---|---|---|---|---|---|
| | | Silica | uptake | uptake | uptake |
| | | Wt. % | 25° C. | 50° C. | 50° C. |
| | | silica of | Wt. % | Wt. % | After aging |
| | Alkoxylated | the total | after 30 | after 10 | at 80° C. |
| Test | PEI No | composite | minutes | minutes | 10 days |
| C Test 1 | C A-PEI 1 | Silica 1 | 4.3 | 6.1 | 2.0 |
| | | 47.5% | | | |
| C Test 2 | C A-PEI 2 | Silica 1 | 5.0 | 6.8 | 2.3 |
| | | 48% | | | |
| Test 1 | A-PEI 1 | Silica 1 | 8.0 | 9.1 | 6.6 |
| | | 48% | | | |
| Test 2 | A-PEI 2 | Silica 1 | 8.7 | 9.6 | 6.8 |
| | | 49% | | | |
| Test 3 | A-PEI 3 | Silica 1 | 9.7 | 10.6 | 8.0 |
| | | 47% | | | |
| Test 4 | A-PEI 4 | Silica 1 | 8.9 | 10.0 | 7.4 |
| | | 47.5% | | | |
| Test 5 | A-PEI 5 | Silica 1 | 9.4 | 11.2 | 6.3 |
| | | 46.7% | | | |
| Test 6 | A-PEI 6 | Silica 1 | 8.9 | 9.9 | 7.0 |
| | | 47.0% | | | |
| Test 7 | A-PEI 7 | Silica 1 | 9.5 | 10.8 | 7.6 |
| | | 47.5% | | | |
| Test 8 | A-PEI 8 | Silica 1 | 9.,7 | 11.1 | 8.9 |
| | | 48.5% | | | |
| Test 9 | A-PEI 9 | Silica 1 | 9.3 | 10.6 | 8.3 |
| | | 49% | | | |
| Test 10 | A-PEI 10 | Silica 1 | 9.8 | 11.8 | 8.8 |
| | | 49.5% | | | |
| Test 11 | A-PEI 11 | Silica 1 | 9.6 | 11.6 | 8.8 |
| | | 48% | | | |
| Test 12 | A-PEI 12 | Silica 1 | 9.9 | 11.0 | 9.1 |
| | | 48.5% | | | |

TABLE 23
Silicas 1-3 loaded with 46.7% to 49.5% alkoxylated PEI

| | | | CO₂ | CO₂ | CO₂ |
|---|---|---|---|---|---|
| | | | uptake | uptake | uptake |
| | | Silica | 25° C. | 50° C. | 50° C. |
| | | Wt % silica | Wt % | Wt % | After aging |
| | Alkoxylated | of the total | after 30 | after 10 | at 80° C. |
| Test | PEI No | composite | minutes | minutes | 10 days |
| C Test 3 | C A-PEI 1 | Silica 1 | 3.9 | 5.6 | 1.9 |
| | | 47.5% | | | |
| C Test 4 | C A-PEI 2 | Silica 2 | 4.6 | 6.0 | 2.0 |
| | | 48% | | | |
| Test 13 | A-PEI 1 | Silica 1 | 7.6 | 9.0 | 6.4 |
| | | 48% | | | |
| Test 14 | A-PEI 2 | Silica 1 | 8.5 | 9.8 | 7.1 |
| | | 49% | | | |
| Test 15 | A-PEI 3 | Silica 2 | 10.3 | 11.5 | 9.0 |
| | | 47% | | | |
| Test 16 | A-PEI 4 | Silica 3 | 8.8 | 10.4 | 8.3 |
| | | 47.5% | | | |
| Test 17 | A-PEI 5 | Silica 3 | 9.2 | 10.7 | 7.0 |
| | | 46.5% | | | |
| Test 18 | A-PEI 6 | Silica 1 | 9.3 | 9.6 | 6.4 |
| | | 47.0% | | | |
| Test 19 | A-PEI 7 | Silica 1 | 9.7 | 10.3 | 7.3 |
| | | 47.5% | | | |
| Test 20 | A-PEI 8 | Silica 1 | 10.0 | 11.4 | 9.0 |
| | | 48.5% | | | |
| Test 21 | A-PEI 9 | Silica 3 | 9.1 | 10.9 | 8.6 |
| | | 49% | | | |
| Test 22 | A-PEI 10 | Silica 1 | 9.4 | 10.4 | 8.5 |
| | | 49.5% | | | |
| Test 23 | A-PEI 11 | Silica 1 | 9.8 | 11.4 | 8.8 |
| | | 48% | | | |
| Test 24 | A-PEI 12 | Silica 2 | 10.4 | 11.7 | 9.4 |
| | | 48.5% | | | |

The results indicate that the Silica-A-PEI products based on alkoxylated polyethyleneimines prepared in the absence of organic solvent either without solvent or in the presence of some water exhibit significantly improved capturing of carbon dioxide by comparison to the Silica-A-PEI products based on alkoxylated polyethyleneimines prepared in the presence of methanol.

1. A sorbent suitable for absorbing carbon dioxide from a mixture of gases comprising:
(A) a polyalkyleneimine or an alkoxylated polyalkyleneimine; and
(B) an inorganic solid support for the polyalkyleneimine or alkoxylated polyalkyleneimine (A),
the polyalkyleneimine or alkoxylated polyalkyleneimine (A) being located on the inorganic solid support (B),
wherein the sorbent comprises water in an amount of greater than 2 wt. % based on the total weight of the sorbent.

2. The sorbent according to claim 1, wherein the sorbent contains <50 ppm of methanol, optionally <50 ppm of a polar organic solvent.

3. The sorbent according to claim 1, wherein the polyalkyleneimine or alkoxylated polyalkyleneimine (A) is a polyethyleneimine or alkoxylated polyethyleneimine.

4. The sorbent according to claim 1, wherein the inorganic solid support (B):
(i) has a pore volume of from 0.7 to 2.0 ml/g;
(ii) has a weight average particle size of at least 0.1 mm; and/or
(iii) is a porous silica.

5. (canceled)

6. (canceled)

7. The sorbent according to claim 1, wherein:
(i) the alkoxylated polyalkyleneimine has an OH/NH molar ratio of from 0.20 to 0.35; and/or
(ii) the amount of polyalkyleneimine or alkoxylated polyalkyleneimine (A) in the sorbent is at least 40% by weight based on the weight of the inorganic solid support (B), optionally from 40% to 60%, by weight based on the weight of the inorganic solid support (B).

8. (canceled)

9. The sorbent according to claim 1 prepared by combining no more than 2 ml of aqueous solvent per g of inorganic solid support (B).

10. The sorbent according to claim 1, in which (A) is an alkoxylated polyalkyleneimine obtainable by a process comprising the steps:
(a) providing a reaction mixture comprising
(i) a polyalkyleneimine, and
(ii) an alkylene oxide;
(b) carrying out a reaction between the polyalkyleneimine (i) and the alkylene oxide (ii) at a temperature of at least 50° C.; and
(c) optionally diluting the product of (b),
wherein the mole ratio of alkylene oxide to NH of the polyalkyleneimine in the reaction mixture is from 0.1 to 0.35, and wherein the reaction mixture comprises <55% water, by weight based on the weight of the reaction mixture, and the reaction mixture comprises <5%, of a polar organic solvent, by weight based on the weight of the reaction mixture.

11. The sorbent according to claim 10, wherein the residual content of alkylene oxide is <150 ppm, by weight based on the weight of the alkoxylated polyalkyleneimine in the composition.

12. The sorbent according to claim 10, wherein the alkoxylated polyalkyleneimine (A) is an alkoxylated polyethyleneimine and the polyalkyleneimine (i) in step (a) is a polyethyleneimine.

13. The sorbent according to claim 10, wherein the reaction mixture comprises <20% water, by weight based on the weight of the reaction mixture and/or the reaction mixture is free from any polar organic solvent.

14. (canceled)

15. The sorbent according to claim 10, wherein:
(i) the mole ratio of alkylene oxide to NH of the polyalkyleneimine in the reaction mixture is from 0.15 to 0.32;
(ii) the polyalkyleneimine in the reaction mixture has a weight average molecular weight (Mw) from 300 to 10,000 g/mol; and/or
(iii) the alkoxylated polyalkyleneimine is branched.

16. The sorbent according to claim 10, wherein the alkylene oxide is a C₂-C₁₂ alkylene oxide.

17. (canceled)

18. (canceled)

19. A process for preparing the sorbent according to claim 1, the process comprising:
loading the polyalkyleneimine or alkoxylated polyalkyleneimine (A) onto the inorganic solid support (B), the loading step comprising contacting (A) and (B) in the presence of aqueous solvent and then obtaining the sorbent.

20. The process according to claim 19, wherein;
(i) contacting (A) and (B) in the presence of aqueous solvent provides a loading mixture and the weight ratio of aqueous solvent to inorganic support (B) in the loading mixture does not exceed 5:1; optionally wherein the weight ratio of aqueous solvent to inorganic support (B) in the loading mixture does not exceed 1.5:1; optionally wherein the weight ratio of aqueous solvent to inorganic support (B) in the loading mixture does not exceed 0.5:1;
(ii) a total volume of liquid in the loading mixture does not exceed 2 ml liquid per gram of inorganic solid support (B); and/or
(iii) wherein the aqueous solvent contains <50 ppm of methanol, optionally <50 ppm or polar organic solvent, based on the weight of the aqueous solvent.

21. (canceled)

22. (canceled)

23. A process for preparing a sorbent suitable for absorbing carbon dioxide from a mixture of gases, the process comprising:
loading a polyalkyleneimine or alkoxylated polyalkyleneimine (A) onto an inorganic solid support (B), the loading comprising contacting (A) and (B) in the presence of aqueous solvent to provide a resulting loading mixture,
wherein the weight ratio of aqueous solvent to inorganic support (B) in the loading mixture does not exceed 5:1,
the method further comprising obtaining the sorbent from the loading mixture, the sorbent comprising the polyalkyleneimine or alkoxylated polyalkyleneimine (A) loaded onto the inorganic solid support (B).

24. The process according to claim 23, wherein:
(i) the sorbent product obtained comprises water in an amount of greater than 2 wt. % based on the total weight of the sorbent;
(ii) the weight ratio of aqueous solvent to inorganic support (B) in the loading mixture does not exceed 3:1, optionally the weight ratio of aqueous solvent to inorganic support (B) in the loading mixture does not exceed 2:1; optionally wherein the weight ratio of aqueous solvent to inorganic support (B) in the loading mixture does not exceed 1.5:1; optionally wherein the weight ratio of aqueous solvent to inorganic support (B) in the loading mixture does not exceed 1:1; optionally wherein the weight ratio of aqueous solvent to inorganic support (B) in the loading mixture does not exceed 0.5:1; and/or
(iii) wherein the total weight of liquid in the loading mixture relative to the weight of inorganic support (B) in the loading mixture does not exceed 10:1; and/or
(iv) wherein the total volume of aqueous solvent used does not exceed 80% of the total pore volume of the inorganic support (B).

25. (canceled)

26. (canceled)

27. The process according to claim 23, wherein the aqueous solvent contains <50 ppm of methanol, optionally <50 ppm or polar organic solvent, based on the weight of the aqueous solvent.

28. The process according to claim 27, wherein the aqueous solvent is water, and wherein the weight ratio of water to inorganic support (B) in the loading mixture is at least 0.2:1.

29. (canceled)

30. The sorbent according to claim 1, wherein the sorbent contains the polyalkyleneimine or alkoxylated polyalkyleneimine (A) in an amount of from 10 wt % to 70 wt % relative to the total weight of the sorbent.

31. A method of using a sorbent as defined according to claim 1, the method comprising using the sorbent for capturing carbon dioxide.

32.-34. (canceled)
